(19) United States
(12) Patent Application Publication
(10) Pub. No.: US 2026/0365805 A1
(43) Pub. Date: Nov. 19, 2026

(54) POLYSUCCINIMIDE POLYMERS, POLYMERIC FILMS, AND PACKAGING FOR COMESTIBLES

(71) Applicant: H. J. Heinz Company Brands LLC, Pittsburgh, PA (US)

(72) Inventors: Kristièn van Tilburg, Dilsen-Stokkem (BE); Stefaan De Wildeman, Dilsen-Stokkem (BE)

(21) Appl. No.: 19/587,345

(22) PCT Filed: Nov. 15, 2024
(86) PCT No.: PCT/US2024/056080

§ 371 Date: May 14, 2026

Related U.S. Application Data
(60) Provisional application No. 63/600,438, filed on Nov. 17, 2023.

(51) Int. Cl. C08J 5/18; C08G 73/10; C08K 5/17

(52) U.S. Cl. CPC C08J 5/18; C08G 73/1092; C08K 5/17; C08J 2367/04; C08J 2479/08

(57) ABSTRACT

Polysuccinimide-containing polymeric material is provided. In one approach, the polysuccinimide-containing polymeric material includes one or more units including an amide moiety and one or more units including a cyclic imide moiety. In another approach, the polysuccinimide-containing polymeric material is combined with a transesterified polyester. The polysuccinimide-containing polymeric films can be used to make packaging films, such as packaging films for use with food products.

### CROSS-REFERENCE TO RELATED APPLICATION

This application claims the benefit of U.S. Provisional Application No. 63/600,438 filed Nov. 17, 2023, which is hereby incorporated by reference in its entirety.

### FIELD

The present application is directed to polymeric materials, including polymeric materials for packaging, and methods of manufacture.

### BACKGROUND

Packaging materials are used to contain and protect a variety of items during storage and transport. A variety of materials such as cardboard, plastics, metal, and glass have historically been used for packaging. However, many packaging materials are deposited in a landfill after use. Non-renewable resources such as petroleum have been used to produce conventional plastics. Though plastic-based packaging may be desirable due to its low cost, packaging materials containing such plastics can persist for a considerable period of time in the environment after disposal. Some polymeric films include polyvinyl alcohol (PVOH), which can be water soluble.

Also, some polymeric materials may not provide sufficient mechanical properties, such as tensile strength, puncture strength, water vapor permeability, and oxygen transmission, that are required for specific applications. For example, while water solubility may be viewed as beneficial in terms of utility in some applications, solubility may limit the usefulness of the material as packaging for liquid food products or food products with a high water activity. Also, the pH of a liquid or food product may be detrimental to the stability of the packaging material during the desired shelf life of the product.

### BRIEF DESCRIPTION OF THE DRAWINGS

FIG. 1 illustrates a perspective view of an embodiment of a polymeric film;

FIG. 2 is a cross-sectional view of the polymeric film shown in FIG. 1;

FIG. 3 is a perspective view of an embodiment of a sachet;

FIG. 4 is a cross-sectional view of the sachet shown in FIG. 3;

FIG. 5 is a perspective view of an embodiment of a sachet;

FIG. 6 is a cross-sectional view of the sachet shown in FIG. 5;

FIG. 7 is a perspective view of an embodiment of a multi-layered polymeric film;

FIG. 8 is a cross-sectional view of the multi-layered polymeric film shown in FIG. 7; and

FIG. 9 is a graph showing degradation and biodegradation test results for sample polymeric films.

### DETAILED DESCRIPTION

Provided herein are polymers containing polysuccinimide and/or polymers derived from polysuccinimide (hereinafter “polysuccinimide polymers” or “PSI polymers”). It has been found that PSI polymers offer unique advantages, including being bio-based (produced from renewable, non-fossil based ingredients) and suitable physical properties (e.g., tensile strength and elongation) for use in packaging films, as well as ease of surface modification to tailor the physical properties of the resulting films, including increased hydrophobicity, and, at least in some approaches, barrier properties, disintegration in compost and/or biodegradation in soil.

The PSI polymers may be used alone or in blends with one or more other polymers to provide polymeric films and packaging materials made from such polymeric films. The PSI-based polymers may also be used as a layer in films along with one or more other polymeric film layers to provide packaging materials. The PSI polymers and polymer blends described herein can be advantageously used to produce and construct food packaging materials, such as packaging films, that can contain a variety of food products, including aqueous comestibles like condiments. In one aspect, food packaging can be in the form of a pouch or sachet. Methods of manufacturing polymers, polymer blends, and polymeric films are also provided. At least in some forms, the polymers and polymer blends are formed of bio-based materials.

The PSI polymers described herein may be provided in the form of films, laminates, pellets, or other granulate forms that may be used to form polymer films, such as in industrial processing and packaging systems. Packaging can include one or more polymers and have specially tailored material properties. In some forms, packaging films can comprise a polymeric material including a structure derived from one or more bio-based components. In some embodiments, the packaging materials might further include one or more additional polymer components, including one or more of polyvinyl alcohol, polyethylene, polypropylene, polyethylene terephthalate, and polystyrene.

In one aspect, polymers can include components derived from an amino acid such as aspartic acid or derivatives thereof. It has been found that polymers and polymer films can include components derived from polysuccinimide (PSI), In some forms, a PSI polymer can be made by polycondensation of aspartic acid. In some aspects, a PSI polymer can be produced by condensation of aspartic acid as follows:

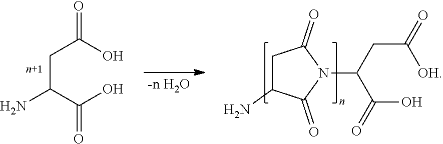

The reaction above yields the repeating cyclic imide unit shown in brackets, which is a repeating polysuccinimide unit.

Aspartic acid can be provided in various forms including L-aspartic acid, D-aspartic acid, or a racemic mixture of the two. L-aspartic acid can be a bio-based raw material obtained from plant and animal sources. Without intending to be bound by any particular theory, it is thought that a racemic mixture of L-aspartic acid and D-aspartic acid can be used to synthesize a PSI polymer having relatively lower crystallinity when compared with PSI polymers synthesized from only L-aspartic acid or only D-aspartic acid. Lower crystallinity is thought to enable synthesis of PSI polymers having relatively higher molecular weight.

A PSI polymer can be synthesized from aspartic acid under a variety of processing conditions. In some forms, a PSI polymer can be synthesized by condensing aspartic acid under a modified atmosphere, such as a nitrogen atmosphere. In other forms, a PSI polymer can be synthesized under other gaseous atmospheres such as air (a mixture of primarily oxygen and nitrogen). In some aspects, water vapor generated by a condensation reaction can generally be removed by any form of collection device. In some forms of laboratory synthesis, a Dean-Stark trap can be employed. In some aspects of industrial processes, a dehydration unit or distillation column can be used to remove water.

A reaction forming PSI polymer by condensing aspartic acid can generally be conducted at any useful temperature. In some aspects, thermal condensation of aspartic acid to a PSI polymer can be conducted at temperatures ranging from about 120 °C to about 250 °C, from about 200 °C to about 240 °C, about 210 °C to about 230 °C, or at about 220 °C.

In various forms, condensation of aspartic acid into a PSI polymer can be conducted in either a batch reaction or a continuous reaction. The condensation of aspartic acid into a PSI polymer can be conducted for any useful reaction period. In some forms, condensation of polyaspartic acid into a PSI polymer can be conducted over a period ranging from about 20 minutes to about 7 hours, or from about 30 minutes to about 6.5 hours, or about 1 hour to about 4.5 hours.

A PSI polymer can be synthesized by polycondensation of aspartic acid with or without a catalyst. In some forms, a PSI polymer can be synthesized by polycondensation of aspartic acid in the presence of a catalyst, such as an acid catalyst. Examples of useful catalysts include inorganic acid and organic acids, such as any one or more of phosphoric acid o-phosphoric acid, metaphosphoric acid, phosphorous acid, hypophosphorous acid, pyrophosphoric acid, diphosphoric acid, polyphosphoric acid, phosphoric anhydride, trichloroacetic acid, p-toluene sulfonic acid, sulfuric acid, methane sulfonic acid, triphenyl phosphite, and tributyl phosphite. These acids may be added as a neat liquid or in the form of an aqueous solution (e.g., 75-100% o-phosphoric acid).

Without intending to be bound by any particular theory, it is thought that some organic catalysts, such as organic acids, can function not only as catalysts during synthesis of a PSI polymer but also provide a lubricating function between molecules during reaction. This lubricating function is thought to avoid undesired variation between molecules of synthesized PSI polymer. Therefore, at least in some approaches, catalysts that also have a lubricating function are preferred. In some aspects, a balance between the catalytic and lubricating functions of an organic acid used as a catalyst can be achieved by including the organic acid in an amount of about 1 to about 50 wt. %, in another aspect about 2 to about 30 wt. %, of the reaction mixture that also includes aspartic acid.

In some forms, a reaction condensing aspartic acid to a PSI polymer is conducted in the presence of o-phosphoric acid as catalyst. In some aspects, a molar ratio of aspartic acid to o-phosphoric acid ranges from about 100:1 to about 1:1, about 50:1 to about 3:1, from about 25:1 to about 5:1, about 20:1 to about 5:1, or from about 15:1 to about 10:1.

In some forms, a PSI polymer can be synthesized from aspartic acid in the presence of a solvent. In some approaches, solvents with a high boiling point (180 °C or higher) may be particularly useful, as they allow the polymerization step to be carried out at high temperature. However, solvents with a lower boiling point (below 180 °C) may also be used if polymerization at high temperatures is not needed. Further, one or more solvents with a lower boiling point may be included in combination with one or more high boiling point solvents. Examples of useful solvents include any one or more of mesitylene, sulfolane, methyl-sulfolane, dimethyl sulfone, dimethyl sulfolane, methyl ethyl sulfone, dodecane, methanol, ethanol, water, hydrochloric acid, acetone, propylene carbonate, toluene, N,N-dimethylformamide, N-methyl-2-pyrrolidone, diethylbenzene, tetralin, and anisole. In other forms, a PSI polymer can be synthesized from aspartic acid in a solventless reaction or a substantially solvent-free reaction.

In some aspects, the amount of solvent used and recycled during synthesis of PSI polymer can be balanced to produce a PSI polymer having desirable high weight-average molecular weight. Without intending to be bound by any particular theory, it is thought that using relatively higher amounts of solvent can reduce polydispersity of polymer in a reaction solution and permit polymeric growth to higher molecular weight. In contrast, it is thought that using relatively lower amounts of solvent can cause a polymer in a reaction solution to have relatively higher polydispersity such that higher molecular weight molecules restrict movement of smaller molecules and impede the increase of molecular weight. It is further thought that use of too much solvent during synthesis of PSI polymer can slow reaction and impede increase of molecular weight. Accordingly, in some forms, a weight ratio of aspartic acid to solvent included in a synthesis process can range from about 1:2.5 to about 1:5.5, or about 1:3 to about 1:5. In some forms, amounts of solvent utilized in synthesis of PSI polymers can be reduced and molecular weight can be increased by later processes such as crosslinking and/or chain extension. Also, inclusion of catalyst can allow for use of less solvent.

In one particular approach, a PSI polymer can be synthesized by condensing aspartic acid in a combination of solvents, such as mesitylene and sulfolane, under a nitrogen atmosphere, and in the presence of an organic acid catalyst, such as o-phosphoric acid. Generally, this homopolymerization reaction method gives larger molecular weight polymers. At least in some approaches, a PSI polymer can have a weight-average molecular weight (Mw) ranging from about 10,000 to about 65,000, about 15,000 to about 64,000, about 25,000 to about 55,000, about 20,000 to about 50,000, or about 30,000 to about 45,000 Dalton.

In other forms, a PSI polymer can be synthesized by reacting maleic anhydride with ammonia, according to the following reaction scheme:

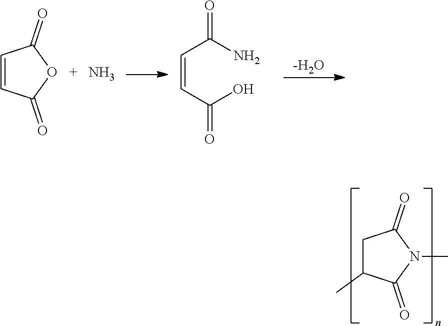

A PSI polymer can be linear or branched and generally include a plurality of polysuccinimide rings according to the following formula, where n is 1 to 30:

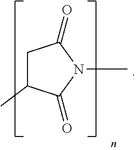

In some forms, a PSI polymer can be a homopolymer of polysuccinimide rings. In other forms, a PSI polymer can be a heterogeneous polymer comprising polysuccinimide rings in addition to different mer units. Polysuccinimide units are generally considered to contribute hydrophobicity to polymeric materials.

For heterogeneous PSI polymers, generally the PSI polymer includes at least about 70 percent polysuccinimide rings of the total number of units in the polymer, in another aspect at least about 75 percent polysuccinimide rings of the total number of units in the polymer, in another aspect at least about 80 percent polysuccinimide rings of the total number of units in the polymer, in another aspect at least about 85 percent polysuccinimide rings of the total number of units in the polymer, in another aspect at least about 90 percent polysuccinimide rings of the total number of units in the polymer, and in another aspect at least about 95 percent polysuccinimide rings of the total number of units in the polymer.

For both homopolymers and heterogeneous polymers, a PSI polymer can have a weight-average molecular weight (Mw) ranging from about 10,000 to about 85,000, about 10,000 to about 75,000, about 10,000 to about 65,000, about 15,000 to about 64,000, about 25,000 to about 55,000, about 20,000 to about 50,000, or about 30,000 to about 45,000 Dalton. In some aspects, number-average molecular weight (Mn) of PSI polymer can range from about 4,000 to about 32,000, about 7,000 to about 30,000, about 10,000 to about 25,000, about 12,000 to about 24,000, or about 14,000 to about 22,000 Dalton. The average molecular weight of one repeating unit in PSI is about 96 Daltons.

In some forms, polydispersity index (PDI) of a PSI polymer can range from about 1.5 to about 4.0, about 2.0 to about 2.5, about 2.5 to about 3.5, about 3.0 to about 3.4, about 1.8 to about 2.2, or about 1.9 to about 2.1. Without intending to be bound by any particular theory, it is thought that opening of polysuccinimide rings of a PSI polymer using reactants such as those provided herein can cause slight reduction in molecular weight of a polymer. Molecular weight can be measured with a Prominence-I LC-2030 PLUS from Shimadzu Corporation with water as eluent and a Shim-pack Bio Diol-120/5 μm column.

In some forms, a PSI polymer can be hydrolyzed by an alkaline compound to provide polyaspartic acid or a polyaspartate salt. Examples of suitable alkaline compounds include alkaline earth metal hydroxides and oxides, and alkali metal hydroxides and oxides. For example, sodium hydroxide, potassium hydroxide, calcium hydroxide, or magnesium hydroxide may be used.

In some forms, polysuccinimide rings comprised in a PSI polymer or a polymer derived from a PSI polymer (e.g., a polyaspartate retaining polysuccinimide rings, a polyaspartic acid retaining polysuccinimide rings, or any other polymer derived from a PSI polymer and retaining polysuccinimide rings) can be opened by a hydrolysis reaction with an alcohol amine to yield one or more units including an amide moiety. Examples of suitable alcohol amines include serine, threonine, methanolamine, ethanolamine, propanolamine, or butanolamine.

In some forms, a PSI polymer or a polymer derived from a PSI polymer can be reacted with an alcohol amine under low temperature conditions such as in an ice bath or a reactor including a cooling system providing sub-ambient reaction conditions. Without intending to be bound by any particular theory, it is thought that reduced temperature can decrease undesired scission of polymer chains during reaction.

In some aspects, a PSI polymer or a polymer derived from a PSI polymer can be reacted with an alcohol amine in a solvent. Suitable solvents include polar (hydrophilic) aprotic solvents with a high boiling point (a boiling point of 180 °C or higher). Examples of useful solvents for such a reaction are N,N-dimethylformamide (DMF) and dimethyl sulfoxide (DMSO).

A PSI polymer or a polymer derived from a PSI polymer can be reacted with an alcohol amine in a batch or continuous reaction. In some forms, a PSI polymer or a polymer derived from a PSI polymer can be reacted with an alcohol amine for times ranging from about 10 minutes to about 16 hours, from about 1 hour to about 8 hours, or from about 2 hours to about 4 hours.

In some forms, a reaction is conducted such that a mass ratio of a PSI polymer or a polymer derived from a PSI polymer to an alcohol amine ranges from about 1.5:1 to about 8:1, about 2:1 to about 7:1, or about 3:1 to about 6:1.

In some forms, polysuccinimide rings comprised in a PSI polymer or polymer derived from a PSI polymer can react with one or more alcohol amines to produce a polymer including units including amide moieties and polysuccinimide units as follows:

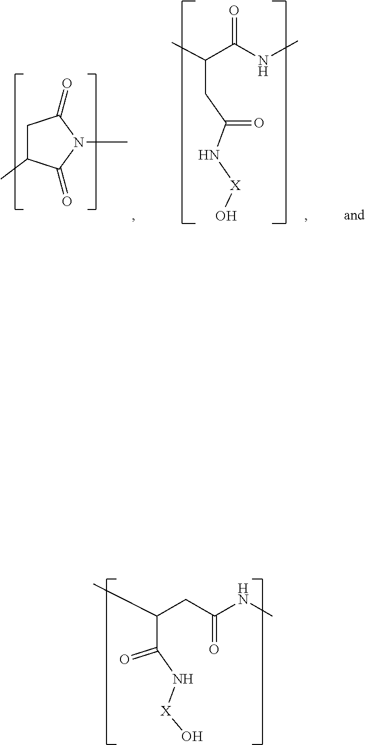

wherein Xs independently represent a divalent group. As the length of the divalent group increases, there may be loss of functionality, as the divalent group becomes apolar as the number of carbon atoms increases. Therefore, in some aspects it is preferred that the divalent groups (X) be relatively short, such as including 1 to 4 carbon atoms. Residual polysuccinimide rings in such a polymer can further react with other reactants provided herein.

In some aspects, a PSI polymer is reacted with ethanolamine according to the following reaction scheme:

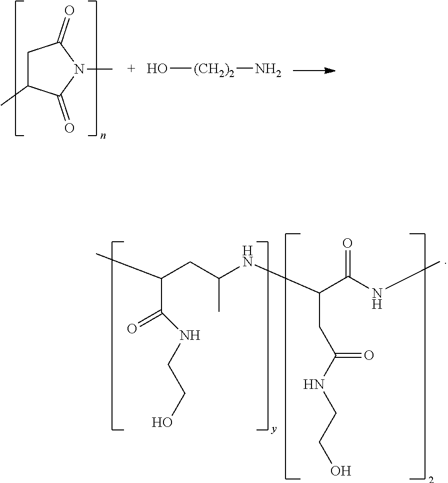

While the product side of the reaction scheme above shows polyaspartamide units derived from reaction between a PSI polymer and ethanolamine, embodiments of a product polymer can retain polysuccinimide rings and include the following units:

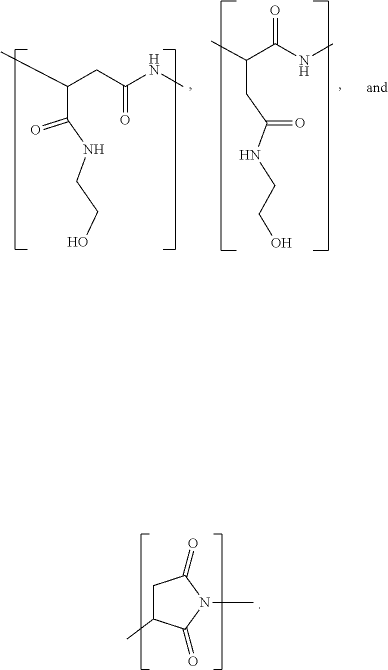

In some forms, the polymer derived from reaction of an alcohol amine and PSI polymer or of an alcohol amine and a polymer derived from PSI polymer can be further reacted with one or more of a cross-linking agent and a chain extender. Examples of cross-linking agents and chain extenders include epoxide compounds such as multi-epoxide compounds, isocyanate compounds such as multi-isocyanate compounds, and amine compounds such as di- or tri-amines, such as for instance hexamethylenediamine.

In some aspects, reacting a PSI polymer or a polymer derived from PSI polymer with one or more fatty amines can introduce into the polymer units including both amide moieties and fatty moieties. In some forms, polysuccinimide rings comprised in a PSI polymer or a polymer derived from a PSI polymer can be hydrolyzed and opened by reaction with one or more fatty amines. In aspects, a fatty amine includes an amine moiety and a group R including 10 to 30 carbon atoms according to the formula: NH₂—R. The R group including 10 to 30 carbon atoms can optionally include any one or more of a saturated hydrocarbon group, an unsaturated hydrocarbon group, and atoms other than carbon. Examples of useful fatty amines include any one or more of decylamine, dodecylamine, pentadecylamine, hexadecylamine, octadecylamine, and oleylamine.

In some aspects, a solution comprising a fatty amine can be applied to a film comprising a polymer including polysuccinimide rings. In some forms, a solution can comprise fatty amine and apolar solvent. Examples of suitable solvents include one or more of acetone, methylethylketone, and ethylacetate. In some forms, a solvent with a boiling point of 100 °C or lower may be preferred so that it can be easily removed from the reaction mixture. Alternatively, a solvent with a higher boiling point may be removed via filtration or crystallization. A solution including fatty amine can be applied spraying or otherwise coating on one or more surfaces of a film. In other forms, a film can be dipped or otherwise immersed in a solution comprising a fatty amine. In yet other forms, a polymer including polysuccinimide rings can be reacted in solution with a fatty amine.

In some aspects, a film including a polymer derived from a PSI polymer, after having been surface treated a fatty amine, can exhibit a water contact angle exceeding about 90°. In other forms, a film including a polymer derived from a PSI polymer that has reacted with a fatty amine can exhibit a water contact angle exceeding about 90°.

At least in some approaches, films treated with relatively high concentrations of fatty amine or including relatively high concentrations of moieties derived from reaction between polysuccinimide rings and fatty amine exhibit higher contact angles when compared with films treated with relatively low concentrations of fatty amine or otherwise including fewer moieties derived therefrom. However, excessive treatment of a film or polymer with one or more fatty amines can result a material having a hydrophilic character due to the hydrolysis of an excessive number of polysuccinimide rings. Therefore, excessive treatment with fatty amine can result in degradation of desirable polymer or film properties via hydrolysis when the fatty amine is included at too high of a concentration or the reaction occurs at too high of a temperature.

Any useful amount of fatty amine can be used to modify any of a PSI polymer, a polymer derived from a PSI polymer, or a film including any one or more of such polymers to achieve the desired level of ring opening. In some forms, a solution including fatty amine and one or solvents can be used to treat a PSI polymer and comprise a weight ratio of fatty amine to solvent ranging from about 0.05:1 to about 0.2:1, or about 0.08:1 to about 0.12:1. In some aspects, one or more fatty amines is provided in an amount sufficient to open about 5% to about 15%, about 8% to about 12%, or about 10% of polysuccinimide rings present in a polymer or polymeric film treated with the fatty amine.

It has been found that polymeric films including moieties derived from reaction between fatty amine and polysuccinimide rings can provide resistance to dissolution by water when incorporated into packaging. In some aspects, such films can be included in packaging as a film layer that faces one or more packaged aqueous substances, such as a condiment (e.g., ketchup), and provide resistance to dissolution of the package and film. In some aspects, such films can be used as one or more exterior faces of a package and provide resistance to dissolution of the package upon contact with moisture outside the package.

In some forms, polysuccinimide rings comprised in a PSI polymer or a polymer derived from a PSI polymer can react with one or more fatty amines to produce a polymer including units including amide moieties and fatty moieties as follows:

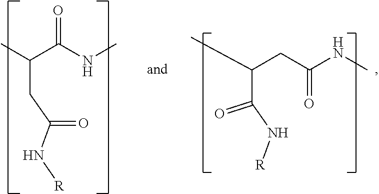

wherein Rs independently represent a monovalent group including 10 to 30 carbon atoms. At least in some aspects, the amide moieties are present in an amount ranging from about 20% to about 80% and fatty moieties are present in an amount ranging from about 20% to about 80%. The precise ratio between the amide and fatty moieties will depend on the fatty amine used. In some forms, polysuccinimide units can also be present in a polymer including the units above. If present, residual polysuccinimide rings can further react with other reactants provided herein.

In some aspects, polysuccinimide rings comprised in a PSI polymer or a polymer derived from a PSI polymer can react with one or more alcohol amines and one or more fatty amines to produce a polymer including units according to the following formulas:

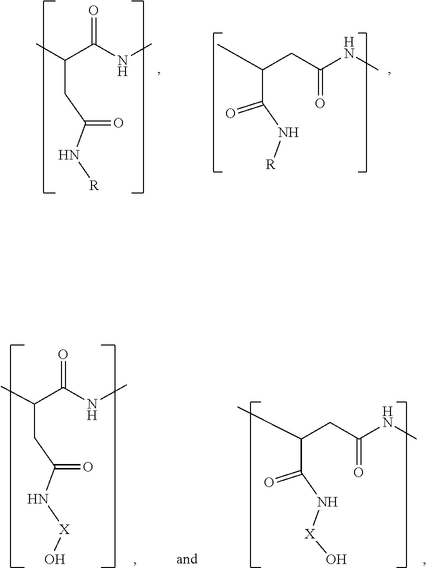

wherein Rs independently represent a monovalent group including 10 to 30 carbon atoms and Xs independently represent a divalent group.

It has been found that retaining a sufficient proportion of polysuccinimide rings after reaction between a PSI polymer (or polymer derived from a PSI polymer) with one or more of an alcohol amine and a fatty amine prevents the product polymer from being overly water soluble. Without wishing to be bound by any particular theory, it is thought that polysuccinimide rings provide reduced water solubility while amide moieties, including pendant hydroxyl groups produced by opening polysuccinimide rings, contribute to water solubility of the polymer. Therefore, the overall water solubility of a polymer can be tailored by adjusting the relative amounts of hydroxyl groups and polysuccinimide rings in a polymer. In some forms, of the total units of a polymer obtained by reaction between a PSI polymer (or polymer derived from a PSI polymer) with one or more of an alcohol amine and a fatty amine, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, or at least 90% are polysuccinimide rings, in another aspect about 10% to about 90%, about 15% to about 90%, about 20% to about 90%, about 25% to about 90%, at least 30% to about 90%, about 35% to about 90%, about 40% to about 90%, about 45% to about 90%, about 50% to about 90%, about 55% to about 90%, about 60% to about 90%, about 65% to about 90%, about 70% to about 90%, about 75% to about 90%, about 80% to about 90%, about 85% to about 90%, or about 90% are polysuccinimide rings.

In some forms, a polymer made by opening polysuccinimide rings of a PSI polymer or polymer derived from a PSI polymer through reaction with one or more alcohol amines can retain at least 30%, at least 35%, at least 40%, at least 45%, at least 50%, at least 55%, at least 60%, at least 65%, at least 70% of units having polysuccinimide rings on the basis total units in the polymer. In another aspect, a polymer made by opening polysuccinimide rings of a PSI polymer or polymer derived from a PSI polymer through reaction with one or more alcohol amines can retain about 30% to about 90%, about 35% to about 90%, about 40% to about 90%, about 45% to about 90%, about 50% to about 90%, about 55% to about 90%, about 60% to about 90%, about 65% to about 90%, or about 70% to about 90% of units having polysuccinimide rings on the basis total units in the polymer. The residual polysuccinimide rings permit subsequent reaction between the rings and other reactants such as any one or more of fatty amine, chain extenders, crosslinkers, acids, or alkaline substances.

In some aspects, a PSI polymer made by opening at least a portion of the polysuccinimide rings includes units including amide moieties according the following formulas:

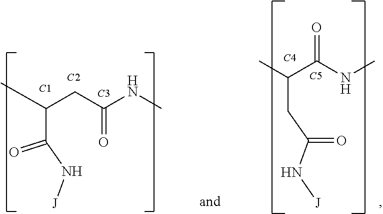

wherein J independently represents a monovalent group. In some forms, one or more additional structures such as polysuccinimide rings can also be present along with the structures shown above. In some aspects, J groups shown in the formulas above can include moieties derived from reaction between polysuccinimide rings and one or more reactants such as alkaline substance, alcohol amines and fatty amines. In some aspects, a ratio of the total number of carbon atoms C1, C2, C3, C4, and C5 in a polymer to a total number of hydroxyl groups comprised in the J monovalent groups ranges from about 2:1 to about 12:1, about 2:1 to about 4:1, about 4:1 to about 6:1, about 4:1 to about 5:1, about 6:1 to about 9:1, about 8:1 to about 12:1, about 3:1 to about 8:1, about 4:1 to about 10:1, or about 4:1 to about 6:1. In some forms, the ratios above can be achieved by reaction of a PSI polymer with an alcohol amine, e.g., ethanolamine.

Without intending to be bound by any particular theory, it is thought that a polymer synthesized to have a relatively higher ratio of the total number of carbon atoms C1, C2, C3, C4, and C5 in the polymer to a total number of hydroxyl groups comprised in the J monovalent groups exhibits lower water solubility when compared to a polymer synthesized to have a relatively lower ratio of the total number of carbon atoms C1, C2, C3, C4, and C5 in the polymer to a total number of hydroxyl groups comprised in the J monovalent groups. It is also thought that the relative number of carbon atoms C1, C2, C3, C4, and C5 to hydroxyl groups can influence biodegradable properties of a polymer. Further, polymers depicted above including units comprising carbon atoms C1, C2, C3, C4, and C5 can further comprise other units such as polysuccinimide rings. Without intending to be bound by any particular theory, it is thought that a polymer synthesized to have a relatively higher proportion of polysuccinimide units exhibits relatively lower water solubility when compared to a polymer synthesized to have a relatively lower proportion of polysuccinimide units.

In some forms, polymer resin for use in making packaging films can include one or more polymers provided herein, such as one or more selected from polymers derived from one or more PSI polymers, and optionally one or more polymers other than polymers derived from a PSI polymer.

A polymer resin can generally take any form such as pellets, granulate, a film, a sheet, a flexible package, or a container. For example, a sheet or film can be formed by extrusion, wet casting, or melt blowing. In some forms, a film or sheet can be formed from pellets. In some forms, a polymeric film can include one or more layers including any of a single polymer or a blend of polymers. In further aspects, a polymeric film can include one or more layers including a blend of polymers, and one or more mono-polymeric layers each including only a single polymer.

In some forms, a polymeric film can comprise a film body comprising a polymer including one or more units including an amide moiety and one or more units including a cyclic imide moiety. In some aspects, one or more units include a cyclic imide moiety comprise a polysuccinimide ring according to the following formula (I):

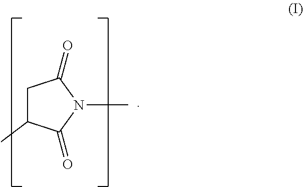

In some forms, one or more units including an amide moiety can be obtained by hydrolyzing/reacting polysuccinimide rings with compounds such as one or more of an acid, an alkaline substance, an alcohol amine, and a fatty amine.

A polymer comprised in a film body of a polymeric film can generally include any number of polysuccinimide rings according to formula (I). In some forms, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, or at least 90% of the total units of a polymer comprised in a film body of a polymeric film have a structure according to formula (I) above. In another aspect, about 5% to about 90%, about 10% to about 90%, about 15% to about 90%, about 20% to about 90%, about 25% to about 90%, about 30% to about 90%, about 35% to about 90%, about 40% to about 90%, about 45% to about 90%, about 50% to about 90%, about 55% to about 90%, about 60% to about 90%, about 65% to about 90%, about 70% to about 90%, about 75% to about 90%, about 80% to about 90%, about 85% to about 90%, or about 90% of the total units of a polymer comprised in a film body of a polymeric film have a structure according to formula (I) above. In yet another aspect, about 5% to about 85%, about 10% to about 85%, about 15% to about 85%, about 20% to about 85%, about 25% to about 85%, about 30% to about 85%, about 35% to about 85%, about 40% to about 85%, about 45% to about 85%, about 50% to about 85%, about 55% to about 85%, about 60% to about 85%, about 65% to about 85%, about 70% to about 85%, about 75% to about 85%, about 80% to about 85%, or about 85% of the total units of a polymer comprised in a film body of a polymeric film have a structure according to formula (I) above. Without intending to be bound by any theory, it is thought that a polymer including relatively higher proportion of polysuccinimide rings exhibits relatively greater hydrophobic properties than a polymer including a relatively lower proportion of polysuccinimide rings.

In some forms, units including an amide moiety that are included in a polymer comprised in a film body comprise units according to the following formulas (II) and (III):

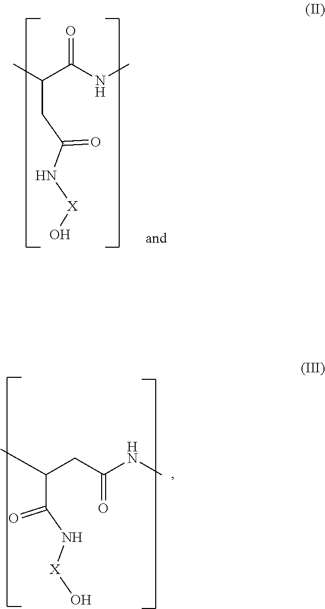

wherein Xs independently represent a divalent group. In some embodiments, a divalent group X includes 1 to 4 carbon atoms. In some forms, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, or at least 90% of the total units of a polymer comprised in a film body of a polymeric film are collectively composed of units according to formulas (II) and (III) above. In another form, about 10% to about 90%, about 15% to about 90%, about 20% to about 90%, about 25% to about 90%, about 30% to about 90%, about 35% to about 90%, about 40% to about 90%, about 45% to about 90%, about 50% to about 90%, about 55% to about 90%, about 60% to about 90%, about 65% to about 90%, about 70% to about 90%, about 75% to about 90%, about 80% to about 90%, about 85% to about 90%, or about 90% of the total units of a polymer comprised in a film body of a polymeric film are collectively composed of units according to formulas (II) and (III) above. In yet another form, about 10% to about 85%, about 15% to about 85%, about 20% to about 85%, about 25% to about 85%, about 30% to about 85%, about 35% to about 85%, about 40% to about 85%, about 45% to about 85%, about 50% to about 85%, about 55% to about 85%, about 60% to about 85%, about 65% to about 85%, about 70% to about 85%, about 75% to about 85%, about 80% to about 85%, or about 85% of the total units of a polymer comprised in a film body of a polymeric film are collectively composed of units according to formulas (II) and (III) above In some embodiments, units including an amide moiety that are included in a polymer comprised in a film body comprise units according to the following formulas (IV) and (V):

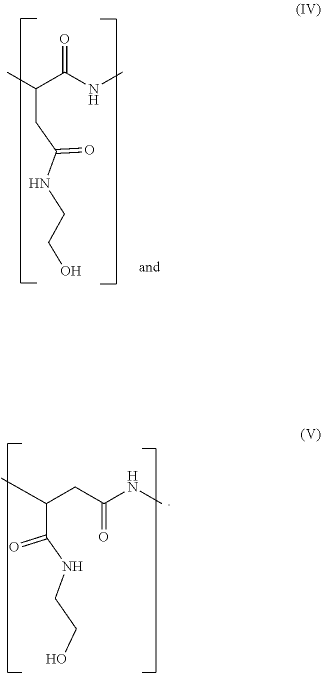

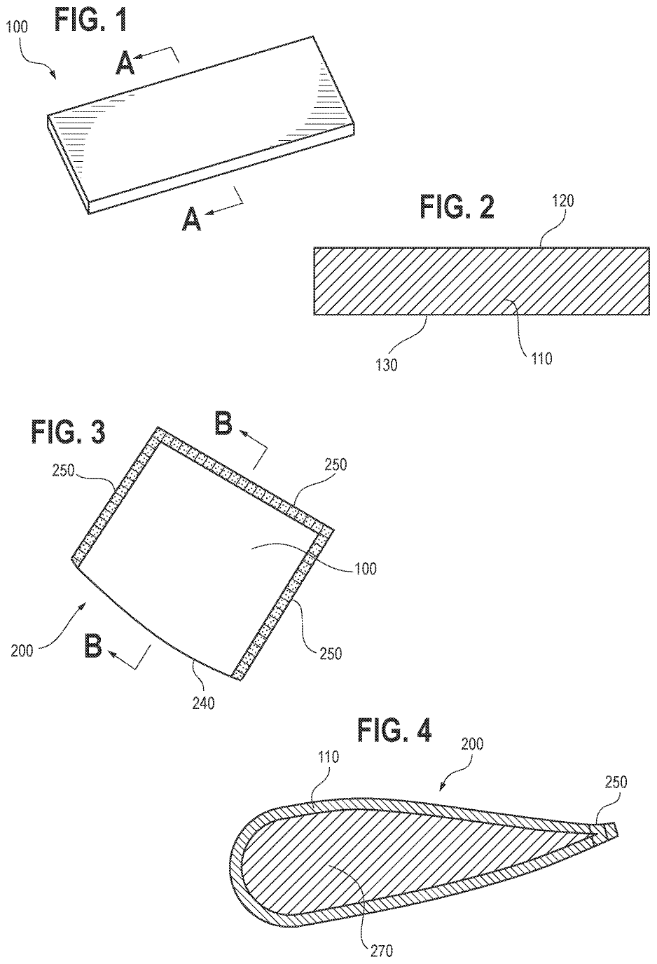

One form of a polymeric film is shown in FIG. 1. More specifically, FIG. 1 is a perspective view of polymeric film 100, and FIG. 2 is a cross-sectional view taken along line A-A of polymeric film 100 in FIG. 1. As shown in FIG. 2, polymeric film 100 includes a film body 110 with a first surface 120 and a second surface 130.

The polymeric film may take a variety of forms and perform a variety of functions. For instance, the polymeric film may be in the form of a monofilm or a multi-layered film. Also, one or more of the first and second surfaces may have a hydrophobic polymer domain, as described herein, to adjust the hydrophobicity of the polymeric film.

The monofilm or multi-layered film might have a thickness in the range of about 25 μm to about 300 μm, about 50 μm to about 250 μm, about 50 μm to about 225 μm, about 50 μm to about 200 μm, about 50 μm to about 150 μm, or about 50 μm to about 125 μm. In another approach, a hydrophobic coating might be applied to one or more surfaces of the monofilm or multi-layered polymeric film. For each, a coating layer might have a thickness of about 10 to about 1 μm to about 100 μm, about 10 μm to about 100 μm, and about 25 μm to about 75 μm.

FIG. 3 illustrates an embodiment of a sachet 200 formed from polymeric film 100. Sachet 200 can be formed by folding polymeric film 100 about folded edge 240 and sealing the remaining three edges 250 of the folded film together. A solid, liquid, or semi-solid substance, such as a food substance, may be dispensed into the folded film prior to sealing all edges together, such dispensing the substance into the sachet as after sealing two of the three non-folded edges. The third edge may then be sealed to enclose the substance. FIG. 4 is a cross-sectional view taken along line B-B of FIG. 3 showing sachet 200 including polymeric film 100 and enclosing substance 270.

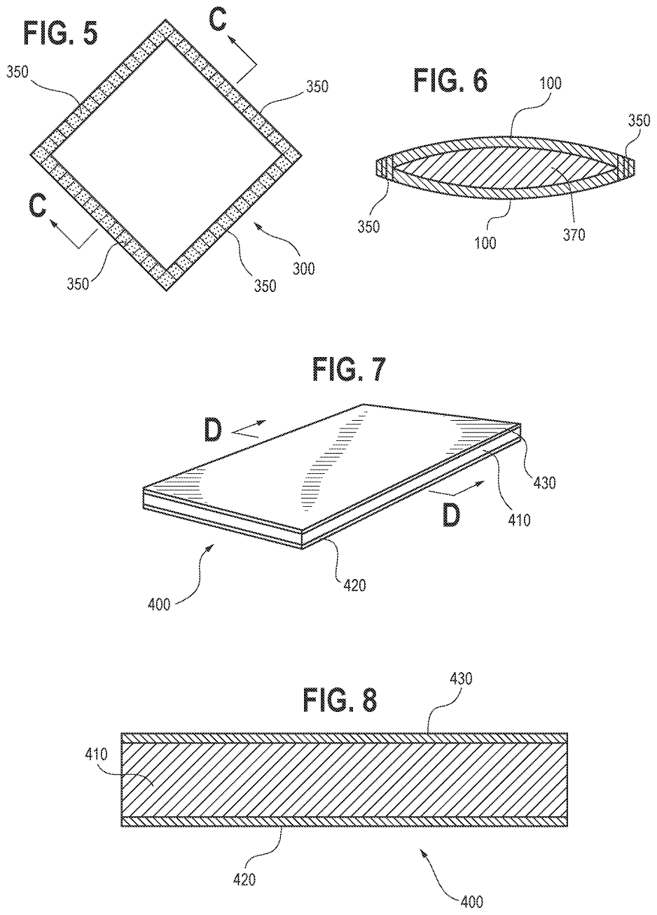

In a different aspect, a sachet may be formed by sealing two pieces of film together at four edges. Again, the polymeric film may be in the form of a monofilm or a multi-layered film. FIG. 5 illustrates an embodiment of a sachet 300 formed by sealing four edges 350 of two pieces of polymeric film 100 of FIG. 1. FIG. 6 is a cross-sectional view taken along line C-C of FIG. 5 showing sachet 300 including two pieces of polymeric film 100 and enclosing substance 370.

FIG. 7 illustrates a multi-layered polymeric film 400. Polymeric film 400 includes central (or core) layer 410, bottom layer 420, and top layer 430. Though shown with three layers here, the multi-layered film might include one or more additional layers depending on the physical properties needed for a particular use of the film. The multi-layered film might also include only two total layers. One or more of the layers might also include a sealant. Also, one or more of the layers of the multi-layered film may be surface treated to increase the hydrophobicity of the surface.

FIG. 8 is a cross-sectional view taken along line D-D of the polymeric film 400 in FIG. 7. FIG. 8 illustrates a core film 410, a bottom layer 420 on one side of core film 410, and an upper layer 430 on an opposite side of core film 410. In some approaches, one or more of the upper and lower layers may be a hydrophobic film. Though shown in FIGS. 7 and 8 with a thicker central film layer, the layers may be of any thickness necessary to provide the necessary physical properties for a given application. The multilayered polymeric film 400 can be used to form a sachet as generally described with respect to FIGS. 2, 4, and 6.

In some forms, a polymeric film can comprise a hydrophobic polymeric domain on at least one surface side of a film body of the polymeric film. A hydrophobic polymeric domain can comprise a polymeric structure that is derived from a polymer that is comprised in a film body of the polymeric film. A hydrophobic polymeric domain can exhibit relatively greater hydrophobic properties than other portions of the film body. Hydrophobicity can be assessed via measurement of the static water contact angle (θ) of a surface and a water droplet. The contact angle (θ) is the angle between a liquid surface and a solid surface where they meet. Generally, if the water contact angle is less than 90°, the surface is considered to be hydrophilic, and if the water contact angle is more than 90 °C, the surface is considered to be hydrophobic. The contact angle can be measured according to ASTM D7334-08 (2022), which is incorporated herein by reference.

In some aspects, a polymeric film can comprise a first hydrophobic polymeric domain on a first surface of a film body of the polymeric film and a second hydrophobic polymeric domain on a second surface of the film body. In some forms, the first hydrophobic polymeric domain and the second hydrophobic domain exhibit relatively greater hydrophobicity than the film body. In some embodiments, the first hydrophobic polymeric domain exhibits relatively greater hydrophobicity than the second hydrophobic polymeric domain. In other embodiments, the first hydrophobic polymeric domain exhibits the same or about the same hydrophobicity as the second hydrophobic domain.

In some aspects, a hydrophobic polymeric domain can be formed on one or more surfaces of a polymeric film by surface treatment of the film body of the polymeric film. In some forms, a hydrophobic polymeric domain can be formed on a polymeric film by treating one or more surfaces of the film with one or more fatty amines. In such a treatment, the polymer present in the film body is chemically altered in the region of surface treatment by reaction with fatty amine. In some forms, a cyclic imide moiety, such as a polysuccinimide moiety present in a polymer of a film body, can be hydrolyzed by reaction with fatty amine to form a new moiety at the area of treatment. This new moiety can include an amide group and a group including a chain of carbon atoms (such as 10 to about 30 carbons). This new moiety imparts hydrophobicity or greater hydrophobicity to the area of treatment and establishes a hydrophobic polymeric domain on a surface of the polymeric film.

In other aspects, a polymeric film can comprise two or more co-extruded films. A co-extruded polymeric film can include one or more co-extruded film bodies comprising a polymer including one or more units including an amide moiety and one or more units including a cyclic imide moiety. One or more co-extruded hydrophobic films can be disposed on one or more sides of a co-extruded film body. The one or more co-extruded hydrophobic films can exhibit relatively greater hydrophobicity than a co-extruded film body. For example, a co-extruded hydrophobic film can include a polymer like that present in the film body with the exception that a cyclic imide moiety in the polymer of the hydrophobic film has been reacted with a fatty amine to introduce units including an amide moiety and a group including a chain of carbon atoms.

In some aspects, one or more fatty amines can be used to form a hydrophobic polymeric domain or a co-extruded hydrophobic film. In some forms, a polymeric structure of a hydrophobic polymeric domain or a co-extruded hydrophobic film comprises units according to the following formulas (VI) and (VII):

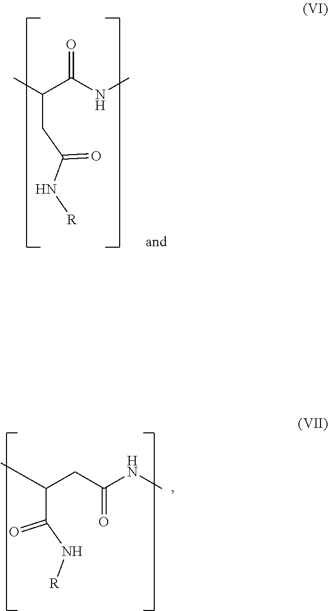

wherein Rs independently represent a monovalent group including 10 to 30 carbon atoms.

In other forms a polymeric structure of a hydrophobic polymeric domain or a co-extruded hydrophobic film comprises units according following formulas (VI) and (VII):

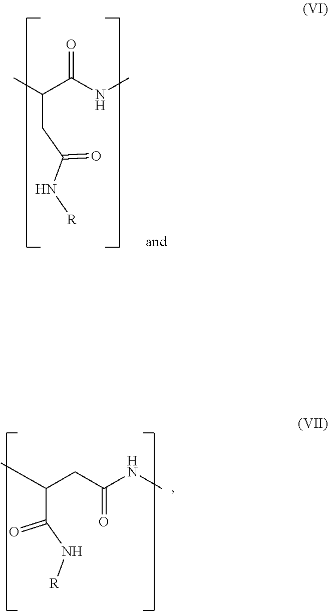

wherein Rs independently represent a monovalent group including 10 to 30 carbon atoms, and units according to at least one of the following formulas (II) and (III):

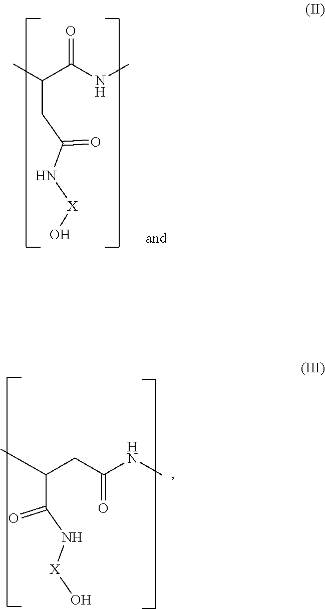

wherein Xs independently represent a divalent group including 1 to 4 carbon atoms. In some aspects, a PSI polymer can be first reacted with an alcohol amine to form a polymer including units according to formulas (I) (II), and (III), and then the resulting polymer can be reacted with a fatty amine to form a polymer including units according to formulas (II), (III), (IV), and (V), and optionally formula (I).

In some forms, a polymeric film or a film body of a polymeric film can include one or more additional polymers other than PSI polymers or polymers derived from PSI polymers. A polymeric film or a film body of a polymeric film can generally include one or more additional polymers in any proportion necessary to provide the desired physical properties to the resulting film product. In some forms, a film body comprises at least 5 wt. %, at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt, %, at least 70 wt. %, at least 75 wt. %, at least 80 wt. %, at least 85 wt. %, or up to about 90 wt. % of one or more additional polymers other than PSI polymers or polymers derived from PSI polymers. Examples of useful polymers include polyester, polyvinyl alcohol (PVOH), polyethylene, polypropylene, polyethylene terephthalate and polystyrene. In one aspect, PVOH included in a film body can generally have any degree of hydrolysis such as a hydrolysis degree of 50% or more, 60% or more, 70% or more, 75% or more, 80% or more, 85% or more, 90% or more, 91% or more, 92% or more, 93% or more, 94% or more, 95% or more, 96% or more, 97% or more, 98% or more, 99% or more.

In some approaches, the one or more PSI polymers described herein can be combined with a polyester, such as one or more of polyethylene terephthalate (PET), polybutylene terephthalate (PBT), polycarbonate (PC), polyhydroxyalkanoate (PHA), polyethylene furanoate (PEF), polybutylene succinate (PBS), polybutylene succinate-co-adipate (PBSA), polybutylene adipate-co-terephthalate (PBAT), poly(3-hydroxybutyrate-co-3-hydroxyhexanoate (PBHB), and polylactic acid (PLA), which will modulate the properties of the resulting packaging films. Advantageously, several of the listed polyesters are bio-based polymers (e.g., PBS, PBSA, PBAT, PBHB, and PLA), though other polyesters may be used given the needs of a given application. At least in some approaches, inclusion of the PSI polymer generally provides strength to the resulting films and permit surface treatment, such as to form a hydrophobic polymeric domain. At least in some approaches, a polyester may be included, such as to act as a carrier, to allow the resulting polymer blend to be used for film blowing and improve sealing properties.

Generally, when combined with a polyester, the PSI is included in an amount of about 1 wt. % to about 15 wt. %, in another aspect about 1 wt. % to about 10 wt. %, in another aspect about 2 wt. % to about 5 wt. %, in another aspect about 3 wt. % to about 5 wt. % based on the total polymer content. In one approach, PSI polymer as described herein is combined with polybutylene succinate (PBS), and the PBS is included in an amount of about 50-96 wt %, in another aspect about 75-96 wt % based on the total polymer content. In another approach, PSI polymer is combined with about 45-65 wt % PBS and 30-55 wt % PBHB based on the total polymer content.

At least in some approaches, the polyesters included in the polymer blends may be treated with oleochemicals, such as a dimer fatty acid, to further increase hydrophobicity of the polyester to improve barrier properties of the resulting polymer blend. For example, a modified polyester can be obtained from transesterifying the polyester with a dimer fatty acid. Generally, the reaction product becomes more hydrophobic with treatment of the dimer fatty acid. At least in some approaches, a modification of about 5% to about 30% is believed to be most useful. At least in some approaches, going above 30% may result in physical properties that are less desirable for use in packaging films.

The transesterified polyester may then be combined with PSI to form a polymer blend. In one approach, the polysuccinimide polymer is included in an amount of about 1 wt % to about 15 wt. % and the transesterified polyester is included in an amount of about 85 wt. % to about 99 wt % based on the combined weight of the polysuccinimide polymer and transesterified polyester. In another approach, the polysuccinimide polymer is included in an amount of about 5 wt % to about 15 wt. % and the transesterified polyester is included in an amount of about 85 wt. % to about 95 wt % based on the combined weight of the polysuccinimide polymer and transesterified polyester. In another approach, the polysuccinimide polymer is included in an amount of about 5 wt % to about 10 wt. % and the transesterified polyester is included in an amount of about 90 wt. % to about 95 wt % based on the combined weight of the polysuccinimide polymer and transesterified polyester.

Suitable dimer fatty acids include, for example, hydrogenated dimer dilinoleic acid, such as RADIACID 0960 from Oleon NV (Ghent, Belgium). When added, these dimer fatty acids may be included in an amount of about 1 wt. % to about 30 wt. %, about 2 to about 20 wt. %, about 2 to about 15 wt. %, about 2 to about 10 wt. %, about 3 to about 10 wt. %, by weight of the total combination of PSI, polyester, and oleochemical.

A polymeric film can generally be made by any suitable process. In some forms, a process comprises providing one or more polymers that include one or more units including an amide moiety and one or more units including a cyclic imide moiety, such as one or more polymers derived from PSI polymer. In some aspects, a process comprises blending such a polymer or polymers with one or more additional polymers that are not derived from a PSI polymer, such as PVOH.

In some forms, a polymer or blend of polymers can be provided neat, i.e., without solvent. In other forms, one or more polymers can dissolve in one or more solvents. In some forms, a process comprises dissolving one or more polymers in a solvent. Examples of useful solvents include water, one or more alcohols such as ethanol, propanol, and butanol, one or more polyols such as glycerin, ethylene glycol, and propylene glycol.

A process of forming a polymeric film can also including forming one or more polymers into a film body by any suitable method. In some forms, a process can comprise casting one or more polymers into a film body. In some embodiments, a process comprises casting one or more polymers dissolved in solvent into one or more molds or trays to form a film body. Any suitable mold or tray can be used, such as those formed polymeric material, silicon, or glass. In some forms, a process can comprise dissolving one or more polymers derived from PSI polymer, or a mixture of such polymer with different polymers such as PVOH, in a solvent and casting the solution. In some embodiments, one or more polymers derived from PSI are dissolved in large excess of water (e.g., water in an amount of about 10 times the mass of the polymer) and the solution is cast in one or more glass trays and evaporated in an oven. In some forms, water can be removed from one or more cast films by drying in ambient conditions or in an oven or other drying device. In some aspects, an oven can be used to dry a film such that oven is set at a temperature ranging from about 40 °C to about 60 °C, or about 50 °C, and the oven applies a vacuum ranging about 100 mbar to about 300 mbar, or about 200 mbar. In other forms, a process can comprise extruding, melt-blowing, or drawing one or more polymers derived from PSI, and optionally one or additional polymers such as PVOH, into film body.

In some aspects, a process comprises treating a surface of a film body with one or more fatty amines to form a hydrophobic polymeric domain on the surface of the film. The hydrophobic polymeric domain can comprise a polymeric structure derived from reaction between one or more fatty amines and one or more polymers present in the film body. The hydrophobic polymeric domain can exhibit relatively greater hydrophobicity than the film body.

In some forms, a process comprises treating a first surface and a second surface of a film body with one or more fatty amines to form a first hydrophobic polymeric domain on the first surface and a second hydrophobic polymeric domain on the second surface. The first hydrophobic polymeric domain and the second hydrophobic polymeric domain can comprise polymeric structures derived from reaction between one or more fatty amines and one or more polymers in the film body. The first hydrophobic polymeric domain and the second hydrophobic polymeric domain can exhibit relatively greater hydrophobicity than the film body.

In some aspects, a process comprises forming a first hydrophobic polymeric domain and a second hydrophobic polymeric domain on opposite surfaces of a film. In some embodiments, a process comprises treating a first surface of a film body with a greater amount of one or more fatty amines than an amount of one or more fatty amines used to treat a second surface, such that a first hydrophobic polymeric domain exhibits greater hydrophobicity than a second hydrophobic polymeric domain. In other embodiments, a process can comprise treating a first surface and a second surface of a film body with about the same amount of one or more fatty amines such that a first hydrophobic polymeric domain exhibits about the same hydrophobicity as a second hydrophobic polymeric domain. In yet other embodiments, a process can comprise treating only one surface of a film body with one or more fatty amines.

In some forms, a process comprises curing a polymeric film after the film is treated with a fatty amine. In some aspects, curing can be conducted by disposing a film in a heated environment for a short period. In some embodiments, curing is conducted by disposing a polymeric film in an oven held at a temperature ranging from about 40 °C to about 60 °C, or about 45 °C to about 55 °C, or about 50 °C for a period ranging from about 2 minutes to about 10 minutes, about 3 minutes to about 8 minutes, or about 4 minutes to about 6 minutes. Without intending to be bound by any particular theory, it is thought that curing imparts strength to a treated film to prevent premature degradation of the film during the intended functional lifetime of the film.

In this disclosure, reference to upper and lower surfaces and layers of the components of a polymeric film refer to an orientation of the components of the film as generally depicted in the figures. Different approaches to the polymeric film will first be generally described, and then more specifics of the various constructions and materials will be explained thereafter.

In some aspects, a process of making a polymeric film comprises extruding one or more core films including one or more polymers that include one or more units including an amide moiety and one or more units including a cyclic imide moiety, such as one or more polymers derived from PSI polymer. The extruded polymer film can optionally include one or more additional polymers not derived from PSI polymer as provided herein. One or more cladding films can be co-extruded with the one or more core films and be disposed on one or both sides of the one or more core films. In some forms, a cladding film can include a polymer produced by reacting a fatty amine with a polymer including one or more units including an amide moiety and one or more units including a cyclic imide moiety, such that the cladding film exhibits hydrophobic properties. Separate polymeric materials for forming one or more core films and one or more cladding films can be co-extruded and fed to a die that disposes layers of the film in the desired order and orientation.

In some aspects, a polymeric film including one or more polymers derived from a PSI polymer as provided herein, or including a polymer including one or more units including an amide moiety and one or more units including a cyclic imide moiety, has a tensile strength and elongation sufficient to suitably package a comestible product.

In some aspects, a polymeric film including one or more polymers derived from a PSI polymer as provided herein has a tensile strength of greater than about 50 N according to ASTM D882. In some forms, such a polymeric film has a tensile strength ranging from about 50 N to about 285 N, about 60 N to about 150 N, or about 70 N to about 112 N. In other aspects, such a polymeric film has a puncture strength sufficient to suitably package an item. In some aspects, such a polymeric film has a puncture strength of greater than about 20 N according to ASTM F1306. In some forms, a polymeric film including one or more polymers as provided herein has a puncture strength ranging from about 23 N to about 155 N, about 70 N to about 130 N, or about 80 N to about 110 N.

In some approaches, a polymeric film including one or more polymers derived from a PSI polymer as provided herein, or packaging film made therefrom, has one or more of an oxygen transmission rate (OTR) of less than about 10 cc/m2/day, less than about 8 cc/m2/day, less than about 6 cc/m2/day, less than about 5 cc/m2/day, less than about 4 cc/m2/day, less than about 3 cc/m2/day, less than about 2 cc/m2/day, or less than about 1 cc/m2/day, and a water vapor transmission rate (WVTR) of less than about 10 cc/m2/day, less than about 8 cc/m2/day, less than about 6 cc/m2/day, less than about 5 cc/m2/day, less than about 4 cc/m2/day, less than about 3 cc/m2/day, less than about 2 cc/m2/day, or less than about 1 cc/m2/day. For purposes herein, OTR and WVTR can be measured according to the procedure of Example 2.

The one or more polymeric films described herein may be sealed to form a sachet or other packaging material. Any suitable sealing method may be used, such as ultrasonic sealing, cold sealing, heat sealing, induction sealing, and the like.

In some forms, a polymeric film including one or more polymers derived from a PSI polymer as provided herein, or including a polymer including one or more units including an amide moiety and one or more units including a cyclic imide moiety, can be used to prepare films, such as may be used for a package or packaging. Generally, packaging can enclose or otherwise contain any type of product. In some aspects, packaging including one or more polymers as provided herein can contain food such as condiments (e.g., ketchup, mayonnaise, mustard, relish, ponzu sauce, oil, vinegar, tartar sauce, fry sauce, and soy sauce), salad dressing, cheese, vegetables, soup, or meat. Examples of food packaging include pouches, sachets, and thermoformed containers. In other forms, packaging can be formed by heat or mechanically sealing one or more films.

In some aspects, packaging as provided herein can generally contain products having any combination of properties. In some aspects, packaging can enclose or otherwise contain a product having a moisture content of ranging from about 1 wt. % to about 99 wt. %, about 5 wt. % to about 95 wt. %, about 10 wt. % to about 90 wt. %, about 20 wt. % to about 80 wt. %, about 30 wt. % to about 70 wt. %, about 40 wt. % to about 60 wt. %, or about 45 wt. % to about 55 wt. %. In some forms, a sachet comprises one or more polymers as provided herein and encloses a condiment, such as ketchup, having a moisture content ranging from about 60 wt. % to about 70 wt. %, in another aspect about 63 wt. % to about 70 wt. %.

Packaging as provided herein can enclose a product having any water activity (α_{w}). In some aspects, packaging can enclose or otherwise contain a product having α_{w} ranging from about 0.05 to about 0.99, about 0.1 to about 0.98, about 0.2 to about 0.9, about 0.3 to about 0.8, about 0.4 to about 0.7, or about 0.5 to about 0.6. In some forms, a sachet comprises one or more polymers as provided herein and encloses ketchup having α_{w} ranging from about 0.91 to about 0.98, about 0.92 to about 0.97, about 0.93 to about 0.96, or about 0.94 to about 0.95.

Packaging as provided herein can enclose a product having any degree of brix (° Bx). In some aspects, packaging can enclose or otherwise contain a product having a degree of brix ranging from about 0.5° Bx to about 95° Bx, about 1° Bx to about 90° Bx, about 5° Bx to about 85° Bx, about 10° Bx to about 80° Bx, about 20° Bx to about 70° Bx, about 30° Bx to about 60° Bx, or about 40° Bx to about 50° Bx. In some forms, a sachet comprises one or more polymers as provided herein and encloses ketchup having degree of brix ranging from about 30° Bx to about 40° Bx, about 31° Bx to about 39° Bx, about 32° Bx to about 38° Bx, about 33° Bx to about 37° Bx, or about 34° Bx to about 36° Bx.

Packaging as provided herein can enclose a product that has a generally basic, acidic or neutral pH. In some aspects, packaging can enclose or otherwise contain a product having a pH of about 3 to about 9, about 4 to about 8, about 4.5 to about 5, about 6 to about 7, about 3.5 to about 7.5, about 4 to about 7, about 4.5 to about 6.5, or about 5 to about 6. In some forms, a sachet comprises one or more polymers as provided herein and encloses ketchup having pH ranging from about 3 to about 4.5, about 3 to about 4, about 3.1 to about 3.9, about 3.8 to about 3.99, or a pH of less than about 4.

In some approaches, a food sachet can comprise a sachet body including a film comprising one or more polymers as provided herein. A food product can be enclosed in the sachet body. In some aspects, a condiment is enclosed in a sachet body. In one particular approach, ketchup having a pH ranging from about 3.2 to about 4.0 is enclosed in a sachet body.

In one approach, the packaging has a structure and composition that is compatible with the packaged item to provide a desired shelf life. In various aspects, this compatibility can avoid or reduce premature degradation and mechanical weakness of packaging material contacting a packaged item, prevent or reduce leaching of materials from the packaging and into contact with a packaged item, or prevent or reduce loss of moisture from a packaged material through the packaging.

In some aspects, packaging can comprise a polymeric film including one or more polymers as provided herein, where one or more of the packaging and the one or more polymers has one or more properties (e.g., chemical composition and mechanical properties) tailored for contact with a particular packaged item.

Packaging as provided herein can be made to include a single layer of film or, in another aspect, two or more layers of film. Similarly, the one or more polymers as provided herein may be layered with other materials such that the one or more polymers may be an inner layer, an outer layer, and/or an intermediate layer.

Coatings may also be used to modify the properties and function of polymer material as provided herein, especially when used as packaging for comestibles. Such coatings include, but are not limited to, waxes, such as beeswax, and other biopolymers.

### EXAMPLES

The following examples are provided to illustrate various embodiments without any limiting effect.

### Example 1—Production of Polysuccinimide Polymers (PSI)

### Procedure 1

A suspension of aspartic acid (25 g, 0.188 mol) and 85%-o-phosphoric acid (9.4 mmol) in mesitylene (56 g) and sulfolane (24 g) was strongly mixed (250 rpm) and refluxed under a N₂ atmosphere at 220 °C. Water formed in a reaction mixture was removed using a Dean-Stark trap with a reflux condenser. After 4.5 hours refluxing in the Dean-Stark trap, the reaction was complete, and the solvent was removed by decanting. The precipitate was washed with water (200 mL) several times until the pH was close to neutral (pH~7). The residue was washed with methanol (MeOH) (200 mL) and dried at 85 °C under reduced pressure to yield a PSI polymer having a weight-average molecular weight of 24,800 g/mol and a PDI of about 2 at 77% yield. Molecular weights were measured with a Prominence-I LC-2030 PLUS from Shimadzu Corporation with water as eluent and a Shim-pack Bio Diol-120/5 μm Column. PSI polymers prepared according to Procedure 1 exhibited PDI ranging from 2.0 to 2.5, providing an average PDI of 2.2.

### Procedure 2

A suspension of aspartic acid (25 g, 0.188 mol) and 85%-o-phosphoric acid (56.4 mmol) in mesitylene (56 g) and sulfolane (24 g) was strongly mixed (250 rpm) and refluxed under a N₂ atmosphere at 220 °C. Water formed in a reaction mixture was removed using a Dean-Stark trap with a reflux condenser. After 4.5 hours refluxing in the Dean-Stark trap, the reaction was complete, and the solvent was removed by decanting. The precipitate was washed with water (200 mL) several times until the pH is close to neutral (pH~7). The residue was washed with MeOH (200 mL) and dried at 85 °C under reduced pressure to yield a PSI polymer having a weight average molecular weight of 64,000 g/mol at 92% yield. Molecular weight was measured using the same method as in Procedure 1. PSI polymers prepared according to Procedure 2 exhibited PDI ranging from 2.0 to 2.5, providing an average PDI of 2.2.

### Procedure 3

A suspension of aspartic acid (25 g, 0.188 mol) and 85%-o-phosphoric acid (56.4 mmol) in propylene carbonate (125 g) was strongly mixed (250 rpm) and refluxed under a N₂ atmosphere at 240 °C. Water formed in a reaction mixture was removed using a Dean-Stark trap with a reflux condenser. After 4.5 hours refluxing in the Dean-Stark trap, the reaction was complete, and the solvent was removed by decanting. The precipitate was washed with water (200 mL) several times until the pH is close to neutral (pH~7). The residue was washed with MeOH (200 mL) and dried at 85 °C under reduced pressure to yield a PSI polymer having a weight-average molecular weight of 10,400 g/mol at 88% yield. Molecular weight was measured using the same method as in Procedure 1. PSI polymers prepared according to Procedure 3 exhibited PDI ranging from 2.5 to 3.5, providing an average PDI of 3.0.

### Procedure 4

A suspension of aspartic acid (25 g, 0.188 mol) and 85%-o-phosphoric acid (56.4 mmol) were mixed for 15 min at room temp. The mixture was transferred in a distillation setup and was heated at 200 °C under a N₂ atmosphere. After 30 min, the reaction mixture changed to a mixture of light-yellow powder and clumps and was ground to a fine powder with a blender. The reaction mixture was reheated at 200 °C for 6.5 hours. The product was washed with water (200 mL) several times until the pH is close to neutral (pH~7). The residue was washed with MeOH (200 mL) and dried at 85 °C under reduced pressure to yield a PSI polymer having a weight-average molecular weight of 25,600 g/mol at 95% yield. Molecular weight was measured using the same method as in Procedure 1. PSI polymers prepared according to Procedure 4 exhibited PDI ranging from 2.5 to 3.5, providing an average PDI of 3.0.

It was found that synthesizing PSI polymers using solvents other than the combination of mesitylene and sulfolane yielded undesired lower molecular weight polymers (e.g., a MW of less than 16,000 Dalton). It is thought that polymers having too low of molecular weight are too mechanically weak, too water soluble, and too brittle (insufficient ductility).

### Modification of PSI Polymer to Introduce Polyaspartamide Moieties

### Procedure 5

Hydrolysis of a PSI polymer was performed in an ice bath by adding 10 g of the PSI polymer, 4.8 g ethanolamine, and 50 ml deionized water into a 100-ml beaker with magnetic stirring. The mixture of the PSI polymer, ethanolamine, and deionized water was stirred for 1 hour under these cooled conditions. Polyaspartamide was precipitated by 200 ml MeOH, and then filtered and dried successfully at 40 °C under a vacuum of 0.095 MPa.

It is estimated that that the amount of ethanolamine used in this procedure resulted in an approximated ratio of the total number of carbon atoms C1, C2, C3, C4, and C5 in a resultant polymer to a total number of hydroxyl groups comprised in the J monovalent groups, according the formulas described hereinabove, ranging from about 1:2 to about 1:2.5. It is thought that this ratio of carbon atoms to hydroxyl groups contributes to the polymer having high solubility in water.

### Procedure 6

Hydrolysis of a PSI polymer was performed in an ice bath by adding 10 g of the PSI polymer, 4.8 g ethanolamine, and 50 ml N,N-dimethylformamide (DMF) into a 100-ml beaker with magnetic stirring. The mixture of the PSI polymer, ethanolamine, and DMF was stirred for 1 hour under these cooled conditions. Polyaspartamide was precipitated by 200 ml MeOH, and then filtered and dried successfully at 40 °C under a vacuum of 0.095 MPa.

It is estimated that about 80% of polysuccinimide rings in the PSI polymer are opened with the amount of ethanolamine used in this procedure, resulting in an approximated ratio of the total number of carbon atoms C1, C2, C3, C4, and C5 in a resultant polymer to a total number of hydroxyl groups comprised in the J monovalent groups, according the formulas described hereinabove, ranging from about 1:2 to about 1:4. It is thought that this ratio of carbon atoms to hydroxyl groups contributes to the polymer having relatively high solubility in water.

### Procedure 7

Hydrolysis of a PSI polymer was performed in an ice bath by adding 10 g of the PSI polymer, 3 g ethanolamine, and 50 ml deionized water into a 100-ml beaker with magnetic stirring. The mixture of the PSI polymer, ethanolamine, and deionized water was stirred for 1 hour under these cooled conditions. Polyaspartamide was precipitated by 200 ml MeOH, and then filtered and dried successfully at 40 °C under a vacuum of 0.095 MPa.

It is estimated that about 50% of polysuccinimide rings in the PSI polymer are opened with the amount of ethanolamine used in this procedure, resulting in an approximated ratio of the total number of carbon atoms C1, C2, C3, C4, and C5 in a resultant polymer to a total number of hydroxyl groups comprised in the J monovalent groups, according the formulas described hereinabove, ranging from about 1:4 to about 1:6. It is thought that this ratio of carbon atoms to hydroxyl groups contributes to the polymer having relatively high solubility in water.

### Procedure 8

Hydrolysis of a PSI polymer was performed in an ice bath by adding 10 g of the PSI polymer, 1.8 g ethanolamine, and 50 ml deionized water into a 100-ml beaker with magnetic stirring. The mixture of the PSI polymer, ethanolamine, and deionized water was stirred for 1 hour under these cooled conditions. Polyaspartamide was precipitated by 200 ml MeOH, and then filtered and dried successfully at 40 °C under a vacuum of 0.095 MPa.

It is estimated that about 30% of polysuccinimide rings in the PSI polymer are opened with the amount of ethanolamine used in this procedure, resulting in an approximated ratio of the total number of carbon atoms C1, C2, C3, C4, and C5 in a resultant polymer to a total number of hydroxyl groups comprised in the J monovalent groups, according the formulas described hereinabove, ranging from about 1:6 to about 1:9. It is thought that this ratio of carbon atoms to hydroxyl groups contributes to the polymer having relatively low solubility in water, but might provide some desirable resistance to dissolution when included in packaging enclosing an aqueous product and might provide some desirable resistance to moisture outside such a package.

### Procedure 9

Hydrolysis of a PSI polymer was performed in an ice bath by adding 10 g of the PSI polymer, 1.5 g ethanolamine, and 50 ml deionized water into a 100-ml beaker with magnetic stirring. The mixture of the PSI polymer, ethanolamine, and deionized water was stirred for 1 hour under these cooled conditions. Polyaspartamide was precipitated by 200 ml MeOH, and then filtered and dried successfully at 40 °C under a vacuum of 0.095 MPa.

It is estimated that about 25% of polysuccinimide rings in the PSI polymer are opened with the amount of ethanolamine used in this procedure, resulting in a ratio of the total number of carbon atoms C1, C2, C3, C4, and C5 in a resultant polymer to a total number of hydroxyl groups comprised in the J monovalent groups, according the formulas described hereinabove, ranging from about 1:8 to about 1:12. It is thought that this ratio of carbon atoms to hydroxyl groups contributes to the polymer having low solubility in water.

### Film Production and Modification Procedures

### Procedure 10

For film production, 5 g of a polymer derived from a PSI polymer to include polyaspartamide units and 15 g PVOH were dissolved in 100 ml water at elevated temperature. The solution was poured in a glass tray where the water was removed at 40 °C under a vacuum of 0.095 MPa. After removal of the water the film could be peeled off the glass.

### Procedure 11

For film production, 10 g of a polymer derived from a PSI polymer to include polyaspartamide units and 10 g PVOH were dissolved in 100 ml water at elevated temperature (at 60 °C). The solution was poured in a glass tray where the water was removed at 40 °C under a vacuum of 0.095 MPa. After removal of the water, the film could be easily peeled off the glass.

### Procedure 12

A top layer of a film was hydrophobized using the following process. An amount of 10 g of octadecyl amine was added to a 100 ml of acetone within a beaker and the mixture was subjected to magnetic stirring. A solution including the fatty amine and solvents was sprayed from a can over film sheets. The solvent was allowed evaporate to under elevated temperature (60 °C) within a vacuum oven.

### Procedure 13

For film production, 1 g of a polymer derived from a PSI polymer to include polyaspartamide units and 19 g polyester were extruded to create a homogeneous blend. After blending, the product was crushed and sieved over a 6 mm sieve, after which it was compressed (at 10 bar) in a press (Zhengzhou CY Scientific Instrument, Model: CY-PCH-600DG) to form a homogeneous film of about 0.2 mm thick. Processing temperatures were set at least 20 °C above the Tu of the highest melting polymer.

### Procedure 14

For film production, 2 g of a polymer derived from a PSI polymer to include polyaspartamide units and 18 g polyester were extruded to create a homogeneous blend. After blending the product was crushed in a hellwig and compressed (10 bar) in a press (Zhengzhou CY Scientific Instrument, Model: CY-PCH-600DG) to form a homogeneous film of 0.2 mm thick. Processing temperatures were set at least 20 °C above the Tₘ of the highest melting polymer.

### Procedure 15—Sachet Production

The produced films are cut in sizes of 40 mm×80 mm. Then two films are laid on each other and 3 out of 4 sides are sealed together with Anova Vacuum Sealer (Anova Applied Electronics, Inc.) to form a sachet. The sachets are then filled with about 3 grams of ketchup. After filling, the open side is sealed to form a fully-closed sachet.

### Procedure 16

A film was prepared according to Procedure 14. A top layer of the film is hydrophobized using the following process. A hydrophobic substance is applied on the film and by heat and compression, using the press procedure of Procedure 14, to melt the hydrophobic substance and spread it homogeneously over the film to provide a hydrophobic layer of about 50 μm. The hydrophobic substance may be a beeswax composition including unhydrolyzed beeswax, such as Beeswax 243248 (CAS 8012-89-3) sold by Sigma-Aldrich.

### Example 2—PSI-Containing Polymer Films

### Sample A

A polymer was prepared by synthesizing PSI polymer according to Procedure 2. The resulting polymer was modified using Procedure 5 to introduce polyaspartamide units. At the same time as conducting Procedure 5, 5 wt. % of hexamethylenediamine was added as a crosslinking agent. A film was constructed from the resulting modified polymer using Procedure 10.

### Sample B

A polymer was prepared by synthesizing PSI polymer according to Procedure 2. The resulting polymer was modified using Procedure 5 to introduce polyaspartamide units. At the same time as conducting Procedure 5, 5 wt. % of hexamethylenediamine was added as a crosslinking agent. A film was constructed from the resulting modified polymer using Procedure 11.

### Sample C

A polymer was prepared by synthesizing PSI polymer according to Procedure 2. The resulting polymer was modified using Procedure 5 to introduce polyaspartamide units. It was found that about 80% of the polyaspartate undergoes ring opening with ethanolamine treatment. A film was then constructed from the resulting modified polymer using Procedure 10. Upon mixing of 5 g PSI polymer produced according to Procedure 5 and 15 g PVOH, there was a total PSI ring content of about 5 wt. % in the blend. Because about 80% of the polyaspartate undergoes ring opening with ethanolamine, this translates to an inclusion of 20 wt % alcohol in the blend from the PSI (excluding the alcohols in the PVOH).

### Sample D

A polymer was prepared by synthesizing PSI polymer according to Procedure 2. The resulting polymer was modified using Procedure 5 to introduce polyaspartamide units. It was found that about 80% of the polyaspartate undergoes ring opening with ethanolamine treatment. A film was then constructed from the resulting modified polymer using Procedure 11. Upon mixing of 10 g PSI polymer produced according to Procedure 5 and 10 g PVOH, there was a total PSI ring content of about 10 weight % in the blend. Because about 80% of the polyaspartate undergoes ring opening with ethanolamine, this translates to an inclusion of 40 wt % alcohol in the blend from the PSI (excluding the alcohols in the PVOH).

### Cold Water Dispersibility and Solubility

A cold water dispersibility test was performed by mixing at least 1 g (dry basis) of the films (having dimensions of at least 25 mm×25 mm) of Samples A through D with 1 L of tap water under stirring conditions (magnetic stir rod) at 150 rpm in a 2 L beaker. The films were stirred for 16 hours at 25 °C±2 °C in the dark. A magnetic stir rod kept the samples in suspension throughout the test. After this period, the films were sieved over a 10 mm screen subjected to determine the water dispersible fraction (D). Water solubility was determined by filtration through a 0.45 μm filter. The tests were performed according to the method of EN 14987 Plastics-Evaluation of disposability in wastewater treatment plants-Test scheme for final acceptance and specifications (2006). Tests were performed in triplicate.

Table 1 below shows the amount of test material, after drying at 50 °C to remove any remaining water, added to 1 L of tap water at the start of the experiment and the amount of material that remained on the 10 mm sieve after the 16-hour test. According to EN 14987 (2006), a material is considered to be cold water dispersible if it produces a dispersible fraction of ≥90% after dissolution in cold water. In order to be cold water soluble, a soluble fraction of ≥90% must be obtained after filtration through a 0.45 μm filter. Table 1 also shows the pH at the start and end of the 16-hour test. According to EN 14987 (2006), the initial pH should be neutral. After the period of stirring, the pH increased for Samples A and B and decreased for Samples C and D. It is believed that a small amount of ethanolamine that didn't react yet with PSI was present, which resulted in a drop in pH for Samples C and D.

TABLE 1

| | Dry | Dry weight | Cold Water | | | | pH after |
|---|---|---|---|---|---|---|---|
| | weight at | >10 mm | Dispersibility (%) | | | pH at | 16 hours |
| Test Materials | start (g) | (g) | Rep. | Avg | SD* | start | of stirring |
| Sample A | 1.0666 | 0.0881 | 91.7 | 93.0 | 1.1 | 7.9 | 8.5 |
| Sample A | 1.0873 | 0.0703 | 93.5 | | | 7.9 | 8.5 |
| Sample A | 1.0552 | 0.0671 | 93.6 | | | 7.9 | 8.6 |
| Sample B | 1.0252 | 0.0 | 100.0 | 100.0 | 0.0 | 8.0 | 8.5 |
| Sample B | 1.0991 | 0.0 | 100.0 | | | 8.0 | 8.6 |
| Sample B | 1.0476 | 0.0 | 100.0 | | | 7.9 | 8.5 |
| Sample C | 0.9991 | 0.0084 | 99.2 | 99.5 | 0.5 | 8.4 | 5.9 |
| Sample C | 0.9996 | 0.0072 | 99.3 | | | 8.0 | 6.6 |
| Sample C | 1.0096 | 0.0 | 100.0 | | | 8.4 | 6.4 |
| Sample D | 1.0041 | 0.0 | 100.0 | 100.0 | 0.0 | 8.3 | 5.9 |
| Sample D | 1.0080 | 0.0 | 100.0 | | | 8.4 | 5.9 |
| Sample D | 0.9998 | 0.0 | 100.0 | | | 8.0 | 6.4 |

*SD = standard deviation

It was found that Samples A, B, C, and D were cold water dispersible. Filtration of Samples A and B proceeded very slowly and/or was not possible through the 0.45 μm filter. Filtration of Samples C and D proceeded very slowly and was not possible through the 0.45 μm filter. Therefore, none of Samples A, B, C, and D were cold water soluble.

### Hot Water Dispersibility and Solubility

A hot water dispersibility test was performed by mixing at least 1 g (dry basis) of films (having dimensions of at least 25 mm×25 mm) of Samples A through D with 1 L of tap water under stirring conditions at 150 rpm in a 2 L beaker. The films were stirred for 16 hours at 60 °C±2 °C in the dark. After this period, the suspension was subjected to the determination of the water dispersible fraction (D) by sieving over a 10 mm sieve. The test was performed in triplicate. Solubility was determined by filtration through a 0.45 μm filter. The test was performed according to EN 14987 (2006).

Table 2 shows the amounts of test material, after drying at 50 °C to remove any remaining water, added to 1 L of tap water at the start of the experiment and the amount of material that remained on the 10 mm sieve after the 16-hour test. According to EN 14987 (2006), a material is considered to be hot water dispersible if it produces a dispersible fraction of ≥90% after dissolution in hot water. In order to be hot water soluble, a soluble fraction of ≥90% must be obtained after filtration through a 0.45 μm filter. Further, according to EN 14987 (2006), the initial pH should be neutral. After the period of stirring, the pH remained more or less stable for Samples A, B, C, and D.

TABLE 2

| | | Dry weight | Hot Water | | | | pH after |
|---|---|---|---|---|---|---|---|
| | Dry weight | >10 mm | Dispersibility (%) | | | pH at | 16 hours |
| Test Materials | at start (g) | (g) | Rep. | Avg | SD* | start | of stirring |
| Sample A | 1.0431 | 0.0 | 100.0 | 100.0 | 0.0 | 8.7 | 8.8 |
| Sample A | 1.0370 | 0.0 | 100.0 | | | 8.6 | 8.8 |
| Sample A | 1.0002 | 0.0 | 100.0 | | | 8.8 | 8.8 |
| Sample B | 1.0690 | 0.0 | 100.0 | 100.0 | 0.0 | 8.6 | 8.7 |
| Sample B | 1.0708 | 0.0 | 100.0 | | | 8.6 | 8.7 |
| Sample B | 1.0032 | 0.0 | 100.0 | | | 8.6 | 8.8 |
| Sample C | 1.0282 | 0.0 | 100.0 | 100.0 | 0.0 | 8.5 | 8.5 |
| Sample C | 1.0444 | 0.0 | 100.0 | | | 8.2 | 8.5 |
| Sample C | 1.0727 | 0.0 | 100.0 | | | 8.5 | 8.5 |
| Sample D | 1.0893 | 0.0 | 100.0 | 100.0 | 0.0 | 8.6 | 8.4 |
| Sample D | 1.0529 | 0.0 | 100.0 | | | 8.6 | 8.4 |
| Sample D | 1.0037 | 0.0 | 100.0 | | | 8.5 | 8.4 |

*SD = standard deviation

It was found that Samples A, B, C, and D were hot water dispersible. However, the filtration of Samples A and B over the 0.45 μm filter proceeded very slowly and/or was not possible, and the filtration Sample C was very difficult and after more than one hour only a few drops passed through the filter. Samples A, B, and C were not hot water soluble.

Sample D was found to be hot water soluble because filtration of Sample D over the 0.45 μm filter was successful.

### Intermediate Temperature Solubility

Samples C and D were tested for intermediate temperature solubility. Six slide frames were split into upper and lower faces, and one was used as a template to cut six replicate samples 4.5 cm×4.5 cm from sample films of both Samples C and D. The cut samples were sealed between upper and lower slide frame faces and snapped closed. Water (400 g) was put into a borosilicate glass beaker with a magnetic stirrer bar and placed on the stirrer hot plate. The stirrer was adjusted to a speed sufficient to provide a downward vortex (swirl) of around 80% of the volume in the flask. A calibrated thermometer was placed in the beaker of water to monitor achieved temperature. A framed sample was clamped and placed in the water held at 40 °C while starting a timer. The framed sample in the beaker was observed for time of film breakdown. The process was replicated for each framed sample using fresh water each time. It was found that films of Samples C and D did not dissolve over a period greater than one hour in the water held at 40 °C in the beaker.

### Disintegration Testing

The purpose of this test is to evaluate the disintegration of a material at ambient temperature in compost to evaluate suitability for home composting. The test set-up was based, with some modifications, on the international standard ISO 20200 Plastics-Determination of the degree of disintegration of plastic materials under simulated composting conditions in a laboratory-scale test (2015), incorporated herein by reference.

Sample A had an initial thickness of about 0.07 mm and Sample B had an initial thickness of about 0.12 mm, as measured with a digital micrometer. The test materials were placed in slide frames, mixed with compost, and incubated at 28 °C±2 °C in the dark. The tests were performed in duplicate per test item. The compost consisted of an 80/20 mixture of <10 mm mature compost and fresh milled vegetable, garden and fruit waste (VGF), respectively. The mature compost was a mixture of mature VGF and green compost. The VGF compost was derived from the organic fraction of municipal solid waste (MSW) and was further stabilized and aerated in a pilot-scale composting bin under controlled conditions in order to obtain completely mature compost. The age of the VGF compost was 14 weeks. The green compost was derived from garden waste, prunings, tree roots and stumps and was stabilized in a full-scale composting plant. The composts were mixed in a ratio of 50% VGF compost and 50% green compost.

The compost was regularly stirred and moistened if needed to provide a moisture content of about 50%. The visual appearance of the slide frames with test material was evaluated.

Minimal disintegration was observed for Samples A and B. For Sample A, after 2 weeks of composting tiny holes started to appear in the test material of one slide frame, while the test material in the other slide frames remained completely intact. The test material was stretchable, and the test material had lost its transparency. During the following weeks no significant progress in disintegration was observed. After 12 weeks of composting tiny holes were noticed in the test material of a few slide frames. However, the test material in the major part of the slide frames still remained intact. At the end of the test (after 16 weeks of composting at ambient temperature) tiny holes were present in the test material of some slide frames, while the test material in the major part of the slide frames still remained completely intact. Based on the remaining surface of test material in the slide frames, test material Sample A was characterized by an average disintegration percentage of 0.1%. For Sample B. Tiny holes were observed in the test material of a few slide frames after 6 weeks of composting. The test material had become stretchable and the test material had lost its transparency. Disintegration slowly proceeded during the following weeks. After 12 weeks of composting, tiny holes were present in the test material of some slide frames, while the test material in the major part of the slide frames remained intact. At the end of the test (after 16 weeks of composting at ambient temperature) tiny holes were noticed in the test material of some slide frames. However, the test material in the major part of the slide frames remained completely intact. Based on the remaining surface of test material in slide frames, Sample B was characterized by an average disintegration percentage of 0.1%.

Sample C had an initial thickness of about 0.138 mm and Sample D had an initial thickness of about 0.170 mm. After 12 weeks, the disintegration of Samples C and D had not yet started and the test materials in all slide frames remained completely intact.

### Weight Loss Testing

Sachets were constructed from films of Samples C and D, filled with ketchup and tested for weight loss over time (i.e., due to moisture loss). Once the sachet has lost 10% moisture, the ketchup becomes darker in color and has a pasty texture, and would be unacceptable to consumers. The sachets were hand sealed using an aluminum heating sealing tong. The results of the testing are shown in Table 3. It was observed that the sachets constructed from films of Samples C and D exhibited weight loss over time, where water or moisture in the ketchup penetrated the hydrophobic coating and film. In Table 3, it is shown that during the first hour of exposure, the hydrophobic coating repels most of the ketchup, but within 6 hours both films lost over 5 weight % of moisture.

TABLE 3
Weight Loss Tests

| Film Samples | 0 Hr | 1 Hr | 2 Hr | 3 Hr | 4 Hr | 5 Hr | 6 Hr | 8 Hr | 1 Day |
|---|---|---|---|---|---|---|---|---|---|
| Sample C | 100% | 99.7% | 98.9% | 97.3% | 96.4% | 95.2% | <95% | <95% | <95% |
| Sample D | 100% | 99.7% | 98.7% | 96.2% | <95% | <95% | <95% | <95% | <95% |

Though both samples had unacceptable weight loss to be used as a monolayer in a packaging film for use with aqueous food products, the film samples could be used in combination with one or more additional film layers to form a packaging film.

### Mechanical and Barrier Testing

Mechanical and barrier testing were conducted on films of Samples C and D. Both film samples demonstrated acceptable tensile strength, elongation, and puncture, though the tensile strength and elongation values were lower than a comparative PVOH film. (No comparative puncture test was performed for PVOH.)

Tensile strength and elongation were tested according to ISO 527-3 using a 2.5 kN universal test machine from Testometric (UK). The tensile strength test was conducted at 500 mm/min. The test specimens had a width of 25 mm and a length of 150 mm. The average thickness of the Sample C films was 0.272 mm and the average thickness of the Sample D films was 0.304 mm. Puncture strength was tested using the same 2.5 kN universal test machine according to ASTM F1306-16 A, using a 3.2 mm (0.125 in.) diameter hemispherical (biaxial stress) probe. The results are presented in Table 4.

TABLE 4
Mechanical Properties

| | ISO 527 | | | | | | |
|---|---|---|---|---|---|---|---|
| | Tensile | | | | ASTM F1306-16 | | |
| Film | Strength | St. dev. | Elongation | St. dev. | Puncture | St. dev. | |
| Samples | (N) | (N) | % | % | (N) | (N) | Criteria >10 |
| Sample C | 285.00 | 21.75 | 109.4 | 48.94 | 155 | — | Yes, Yes |
| Sample D | 111.79 | — | 129.3 | — | 23 | — | Yes, Yes |
| PVOH | 696.54 | 102.61 | 170.33 | 140.48 | — | — | Yes, Yes |
| (control) | | | | | | | |

Water vapor transmission rate (WVTR) was measured using a method based on ASTM F1249. Conditions for WVTR measurement are shown below.

| | |
|---|---|
| Rate of flow of wet nitrogen on test gas side | 20 (cc/min) |
| Rate of flow of the nitrogen carrier gas | 10 (cc/min) |
| Size of area exposed to permeation | 5 cm² |
| Conditioning procedure | 60 minutes bypass |
| Temperature of test environment | 38 °C; 90% RH |
| Apparatus used | Permatran W 3-34 |

Oxygen transmission rate (OTR) was measured using a method based on ASTM D3985 & ASTM F1927. Conditions for OTR measurement are shown below.

| | |
|---|---|
| Rate of flow of wet nitrogen on test gas side | 20 (cc/min) |
| Rate of flow of the nitrogen carrier gas | 10 (cc/min) |
| Conditioning procedure | 30 minutes bypass |
| Size of area exposed to permeation | 5 cm² |
| Temperature of test environment | 23 °C; 0% RH |
| Apparatus used | Systech 8001 Oxygen |
| | Permeation Analyzer |

The results of the OTR and WVTR testing are provided in Table 5.

TABLE 5
Oxygen and Water Vapor Barrier Properties

| | Oxygen | Water vapor | Criteria |
|---|---|---|---|
| Film | Transmission | Transmission | Met |
| Samples | (cc/m²/day) | (cc/m²/day) | <10 |
| Sample C | 30.9 | 890 | No |
| Sample D | 17.15 | 890 | No |

While tensile strength and puncture strength were deemed acceptable, oxygen transmission rate and water vapor transmission rate are too high for use in films for use with aqueous food products.

The sample films could be combined with a hydrophobic coating or in combination with one or more other film layers to improve the oxygen transmission rate and water vapor transmission rate of the overall film structure.

Samples D (with 10% PSI) was weaker than Sample C (with 5% PSI), which indicates that the polymer acts as a nucleating agent. Therefore, it was determined that using less ethanolamine could be effective to improve film strength.

### Example 3—Additional PSI-Based Polymers

Further adjustments were made to improve the properties of the films. Additional samples (E-J) were prepared and analyzed. These samples received 0% aspartate, which allows the polymer to be more hydrophobic. It was found that lower quantities of PSI ring opening resulted in lower solubility in water. Further, the lower the amount of aspartate, the more hydrophobic the polymer became, which resulted in better water barrier properties (by visual observation). Generally, Samples E and F had lower molecular weight and were more hydrophilic due to more ring opening, and Samples G, H, I, and J had higher molecular weight and varied between 25-30% ring opening.

### Sample E

A polymer was prepared by synthesizing PSI polymer according to Procedure 1. The resulting polymer was modified using Procedure 5 to introduce polyaspartamide units. A film was constructed from the resulting modified polymer using Procedure 10.

### Sample F

A polymer was prepared by synthesizing PSI polymer according to Procedure 3. The resulting polymer was modified using Procedure 5 to introduce polyaspartamide units. A film was constructed from the resulting modified polymer using Procedure 10.

### Sample G

A polymer was prepared by synthesizing PSI polymer according to Procedure 2. The resulting polymer was modified using Procedure 8 to introduce polyaspartamide units. A film was constructed from the resulting modified polymer using Procedure 10. The resulting film was modified using Procedure 12.

### Sample H

A polymer was prepared by synthesizing PSI polymer according to Procedure 2. The resulting polymer was modified using Procedure 9 to introduce polyaspartamide units. A film was constructed from the resulting modified polymer using Procedure 10. The resulting film was modified using Procedure 12.

### Sample I

A polymer was prepared by synthesizing PSI polymer according to Procedure 2. The resulting polymer was modified using Procedure 8 to introduce polyaspartamide units. A film was constructed from the resulting modified polymer using Procedure 11. The resulting film was modified using Procedure 12.

### Sample J

A polymer was prepared by synthesizing PSI polymer according to Procedure 2. The resulting polymer was modified using Procedure 9 to introduce polyaspartamide units. A film was constructed from the resulting modified polymer using Procedure 11. The resulting film was modified using Procedure 12.

### Example 4—Films Prepared with PSI-Polyester Blends

Additional polymer blends were prepared according to Table 6. PSI polymers, prepared without ring opening treatment, were combined with polyester polymers. Despite the inherent brittleness introduced by highly crystalline PSI, the chosen concentrations of 5% and 10% PSI demonstrate improved mechanical properties, with 5% PSI generally performing better than 10% PSI.

Except for Blends 9A and 10A, the polymers were prepared by synthesizing PSI polymer according to Procedure 2. The PSI polymer and one or more of polybutylene succinate (PBS), polybutylene succinate-co-adipate (PBSA), polybutylene adipate-co-terephthalate (PBAT), poly(3-hydroxybutyrate-co-3-hydroxyhexanoate (PBHB), and polylactic acid (PLA) were melted and mixed via extrusion blending. These blends had a similar amount of PSI rings as Sample C above.

For Blends 9A and 10A, the PSI polymer was produced according to Procedure 1. Hydrogenated dimer dilinoleic acid (Radiacid 0960 from Oleon NV) was separately added to polybutylene succinate (PBS) at 200 °C and mixed to allow transesterification to occur. Water was removed via polycondensation for about 4 hours. The modified polyester was then pelletized and granulated before being combined with the PSI polymer and mixed via extrusion blending. After blending, the product was crushed and sieved over a 6 mm sieve, after which it was compressed (at 10 bar) in a press (Zhengzhou CY Scientific Instrument, Model: CY-PCH-600DG) to form a homogeneous film of about 0.2 mm thick. Processing temperatures were set at least 20 °C above the Tₘ of the highest melting polymer.

TABLE 6

| | | Polyester | | | | |
|---|---|---|---|---|---|---|
| | | | | | Poly(3- | |
| | | | Polybutylene | Polybutylene | hydroxybutyrate- | |
| | | Polybutylene | succinate-co- | adipate-co- | co-3- | Polylactic |
| | | succinate | adipate | terephthalate | hydroxyhexanoate) | acid |
| Polymer | PSI | (PBS) | (PBSA) | (PBAT) | (PHBH) | (PLA) |
| Blends | (%) | (%) | (%) | (%) | (%) | (%) |
| Blend 1-A | 5% | 72.2 | — | — | 3.8 | 19 |
| Blend 1B | 10% | 68.4 | — | — | 3.6 | 18 |
| Blend 2-A | 5% | 36.1 | 36.1 | — | 3.8 | 19 |
| Blend 2-B | 10% | 34.2 | 34.2 | — | 3.6 | 18 |
| Blend 3-A | 5% | 36.1 | — | 36.1 | 3.8 | 19 |
| Blend 3-B | 10% | 34.2 | — | 34.2 | 3.6 | 18 |
| Blend 4-A | 5% | 76 | — | — | 19 | — |
| Blend 4-B | 10% | 72 | — | — | 18 | — |
| Blend 5-A | 5% | 95 | — | — | — | — |
| Blend 5-B | 10% | 90 | — | — | — | — |
| Blend 6-A | 5% | — | — | — | — | 95 |
| Blend 7-A | 5% | 57 | — | — | 38 | — |
| Blend 8-A | 5% | 38 | — | — | 57 | — |
| Blend 9A** | 5% | 75% | — | — | — | — |
| Blend 10-A** | 5% | 85% | — | — | — | — |

**For Blend 9-A, 20 wt % Radiacid 0960 was first added to the PBS for the transesterification reaction. For Blend 10-A, 10 wt % Radiacid 0960 was first added to the PBS for the transesterification reaction.

The polymer blends were prepared into films using Procedure 13 (for blends with an “A”) and Procedure 14 (for blends with a “B”). The films had a thickness of approximately 0.2 mm.

Barrier and mechanical testing was performed using the following conditions:

| Tensile (ISO 527) | Puncture (ASTM F1306-16) |
|---|---|
| Machine: Tinius Olsen 5 kN tensile tester | Machine: MTS 10/M |
| Gage Length 100 mm | Loadcel: 100N |
| Width 35 mm | Test speed: 5 mm/min |
| Thickness ~0.2 mm | Preload: 1N |
| Preload 5N | Replicates: 10 |
| Elastic speed 0.5 mm/min | |
| Plastics speed: 50 mm/min | |
| Replicates: 3-6 | |

The overall best performing samples were further analyzed for mechanical properties. The mechanical testing results are presented in Table 7.

TABLE 7
Mechanical Properties

| | ISO 527 | | | | | | |
|---|---|---|---|---|---|---|---|
| | Tensile | | | | ASTM F1306-16 | | |
| Test | Strength | St. dev. | Elongation | | Puncture | St. dev. | Criteria |
| Material | (N) | (N) | % | St. dev. % | (N) | (N) | Met >10 |
| PVOH | 696.54 | 102.61 | 170.33 | 140.48 | — | — | — |
| (control) | | | | | | | |
| Blend 1-A | 330.78 | 35.44 | 1.33 | 0.18 | — | — | — |
| Blend 1-B | 256.12 | 24.29 | 1.08 | 0.10 | — | — | — |
| Blend 2-A | 242.25 | 40.29 | 1.24 | 0.11 | — | — | — |
| Blend 2-B | 236.95 | 58.35 | 1.19 | 0.19 | — | — | — |
| Blend 3-A | 239.40 | 50.19 | 1.44 | 0.24 | — | — | — |
| Blend 3-B | 148.96 | 39.94 | 1.10 | 0.30 | — | — | — |
| Blend 4-A | 404.10 | 25.58 | 2.56 | 0.23 | 26 | 4 | ✓✓ |
| Blend 4-B | 231.74 | 58.75 | 1.35 | 0.28 | — | — | — |
| Blend 5-A | 381.86 | 97.84 | 2.89 | 0.77 | — | — | — |
| Blend 5-B | 68.02 | 35.57 | 0.36 | 0.17 | — | — | — |
| Blend 6-A | 814.80 | 133.01 | 1.11 | 0.23 | — | — | — |
| Blend 7-A | 333.41 | 48.27 | 1.72 | 0.19 | 16 | 5 | ✓✓ |
| Blend 8-A | 285.67 | 41.27 | 1.17 | 0.19 | — | — | — |
| Blend 9-A | 137.28 | 4.99 | 0 | — | 7 | 2 | ✓X |
| Blend 10-A | 484.95 | 55.23 | 8.02 | 1.75 | 30 | 3 | ✓✓ |

The mechanical test results demonstrate acceptable tensile strength and elongation for nearly all tested blends. Samples 4A, 7A, 9A, and 10A were also tested for puncture resistance. All but Sample 9A had acceptable puncture resistance.

Differential Scanning calorimetry (DSC) and Thermogravimetric Analysis (TGA) testing was performed for Samples 4-A, 7-A, 9-A, and 10-A to understand the thermal properties of the films and to confirm suitability for use in packaging films. The Tₘ (melting temperature), T. (crystallization temperature), and Ta (decomposition temperature). Results are presented in Table 8 (1 sample each except as noted). With the Ta value for each polymer being significantly higher than the Tₘ value, all polymers would be suitable for undergoing processing necessary to prepare packaging films, such as via blown film extrusion.

TABLE 8

| Polymer Samples | Tₘ (°C) | T_{c} (°C) | T_{d} (°C) |
|---|---|---|---|
| 4-A | 118.6 & 160.9 | 76.0 | ~275 |
| 7-A | 114.1 | 76.1 | ~275 |
| 9-A | 87.6 | 0.2 | ~300 |
| 10-A | 89.5 | 19.3 | ~300 |

### Example 5—Weight Loss Test for Films

Weight loss testing was also performed for Polymer Blends 1-A, 4-A, 7-A, 9-A, and 10-A. Sachets were prepared with films formed by the polymer blends, and the sachets were filled with ketchup. The target weight loss was less than 3% weight loss after one week. The weight loss results are shown in Table 9 (based on four replicates). The sachet for Sample 5-A did not seal and could not be tested. Film samples coated with beeswax according to Procedure 16 failed to seal to form sachets and could not be tested. Therefore, all results shown below are for non-hydrophobized samples.

TABLE 9

| | Average Weight Loss by Days | | | | | | | | | | |
|---|---|---|---|---|---|---|---|---|---|---|---|
| Sample | 0 | 1 | 5 | 6 | 7 | 8 | 13 | 20 | 27 | 34 | 42 |
| 1-A | 0 | 0.51 | 2.36 | 2.81 | 3.38 | 3.88 | 6.43 | 9.87 | 13.13 | 16.6 | 25.93 |
| 4-A | 0 | 0.69 | 3.3 | 3.94 | 4.57 | 5.36 | 8.77 | 13.44 | 18.01 | 22.45 | NA |
| 7-A | 0 | 0.38 | 1.79 | 2.13 | 2.48 | 2.92 | 5.07 | 7.19 | 9.65 | 12.28 | 22.0 |
| 9-A | 0 | 1.63 | 7.53 | 9.1 | 10.55 | 12.33 | 19.64 | 28.82 | 36.55 | 41.46 | NA |
| 10-A | 0 | 3.35 | 14.93 | 17.47 | 20.19 | 23.23 | 32.69 | 41.7 | 46.11 | 47.94 | NA |

The seals of the sachets began to fail for several of the samples, including Sample 1-A after 6 days, 4-A after 20 days, and 7-A after 13 days. The ketchup in Samples 9-A and 10-A became darker in color and dry.

Sample 7-A performed the best of all tested samples, taking about 9 days before reaching 3% weight loss and about 25 days before reaching 9% weight loss. Sample 1-A was the next best performing sample, taking about 7 days before reaching 3% weight loss and about 20 days before reaching 9% weight loss.

The results indicate that the film samples had unacceptable weight loss to be used as a monolayer in a packaging film for use with aqueous food products. However, due to the numerous other beneficial physical properties and the ability to tailor the properties (e.g., weight loss, disintegration, and biodegradation) of these films, the film samples could be used in combination with one or more additional film layers to form a packaging film for use with aqueous food products.

### Example 6—Barrier Testing of Hydrophobized Films

Films were formed from Blends 4-A, 7-A, 9-A, and 10-A. The films were hydrophobized with a beeswax coating of about 50 μm on one side of the film. The beeswax coating was applied according to Procedure 16. Barrier testing was performed as described below.

Water vapor transmission rate (WVTR) was measured using a method based on ASTM F1249 with the conditions listed below. The orientation of the film during the test was “inside towards outside” (because water vapor is transmitted from inside to outside a sachet containing a condiment, the test is conducted from the inside to outside of the film sample, with the beeswax coating on the inside surface of the film).

Conditions for WVTR measurement are shown below.

| | |
|---|---|
| Rate of flow of wet nitrogen on test gas side | 20 (cc/min) |
| Rate of flow of the nitrogen carrier gas | 10 (cc/min) |
| Size of area exposed to permeation | 5 cm² |
| Conditioning procedure | 60 minutes bypass |
| Temperature of test environment | 23 °C; 100% RH |
| Apparatus used | Mocon Permatran-W 700 |

Oxygen transmission rate (OTR) was measured using a method based on ASTM D3985 & ASTM F1927. The film orientation during the test was “outside towards inside” (because oxygen is transmitted from outside to inside a sachet containing a condiment, the test is conducted from the outside to inside of the film sample, with the beeswax coating on the inside surface of the film). Conditions for OTR measurement are shown below.

| | |
|---|---|
| Rate of flow of wet nitrogen on test gas side | 20 (cc/min) |
| Rate of flow of the nitrogen carrier gas | 10 (cc/min) |
| Conditioning procedure | 30 minutes bypass |
| Size of area exposed to permeation | 5 cm² |
| Temperature of test environment | 23 °C; 90% RH |
| | (at inside sample), |
| | 50% RH (at outside |
| | sample), 100% O₂ |
| Apparatus used | Mocon Ox-tran SH2 |

The oxygen and water vapor transmission results are presented in Table 10.

TABLE 10

| | Oxygen | Water Vapor | |
|---|---|---|---|
| | Transmission | Transmission | Criteria |
| | (cc/m²/day) | (cc/m²/day) | <10 |
| Blend 4-A | 28 ± 6 | 8.3 ± 7.4 | X ✓ |
| Blend 7-A | 27 ± 2 | 13.4 ± 7.8 | X X |
| Blend 9-A | 316 ± 61 | 3.3 ± 0.4 | X ✓ |
| Blend 10-A | 123 ± 8 | 7.1 ± 0.7 | X ✓ |

It is generally expected that a polymer blend will have acceptable oxygen transmission or water vapor transmission but not both. This is because oxygen is apolar and water is polar. Hydrophobized films formed from blends 4-A, 9-A, and 10-A had the best water vapor transmission results. For example, packaging films prepared from these polymer blends could be combined with one or more additional polymer film layers or coatings to improve the oxygen transmission properties of the overall film structure.

### Example 7—Disintegration and Biodegradation Testing of Polymer Blends

Disintegration. Because Polymer Blends 4-A, 7-A, 9-A, and 10-A were the best performing samples, disintegration testing was also conducted using about 35×about 35 mm film pieces having a thickness of about 200 microns. Each of the films was coated on one side with about 50 μm Beeswax 243248 (CAS 8012-89-3; sold by Sigma-Aldrich) as set forth in Procedure 16.

Home composting test conditions were according to ISO 20200, as described in Example 2. The test was carried out for 180 days. The disintegration test results are presented in Table 11.

TABLE 11

| | Weight at | Weight at | Disintegration |
|---|---|---|---|
| Sample | start (g) | end (g) | (%) |
| Blend 4-A | 5.8765 | 5.3568 | 8.8 |
| Blend 7-A | 6.3639 | 4.5347 | 28.7 |
| Blend 9-A | 5.7269 | 5.4254 | 5.3 |
| Blend 10-A | 6.0750 | 0 | 100 |

Of the four blends, Blend 10-A was the best performing. Blend 10-A showed signs of disintegration within 30 days and was completely degraded by 70 days. The second-best degrading film was Blend 7-A.

Biodegradation. Biodegradation testing was performed on each of the polymer samples using ISO 17556 (biodegradation in soil) for 148 days. ISO 17556 is an aerobic biodegradation test that determines the biodegradability of a material in soil and relies on the microorganisms present in soil without the addition of a specific inoculum. The level of biodegradation, expressed as a percentage, is determined by comparing the oxygen consumption with the theoretical oxygen demand (ThOD) or by comparing the amount of CO₂ evolved with the theoretical amount (ThCO₂). The present test was performed by comparing the amount of CO₂ evolved with the theoretical amount (ThCO₂). The temp was maintained at 25 °C. Soil is natural soil collected from the surface layer of fields and/or forests and sieved to give particles of less than 5 mm in size. Experiments were performed in triplicate in separate reactors containing soil.

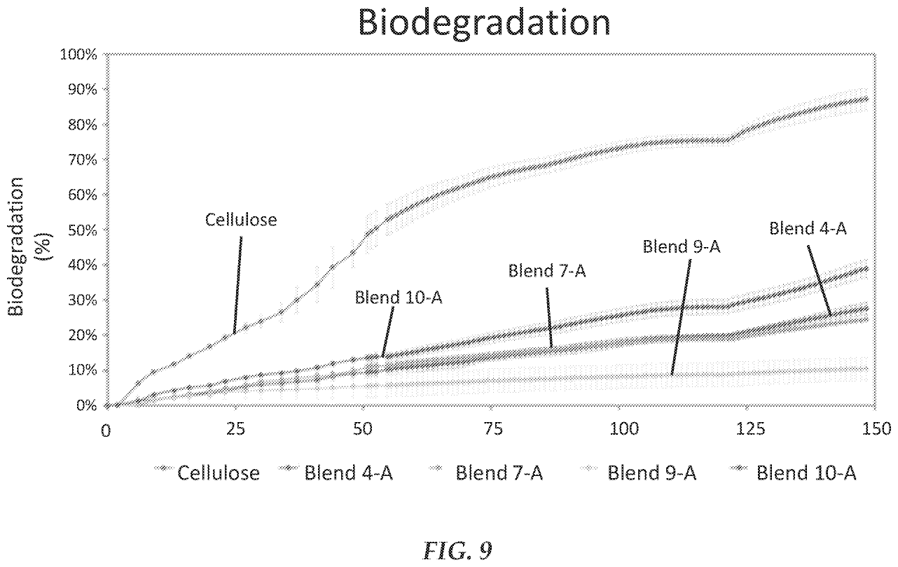

The polymer samples were compared to a cellulose powder control. The biodegradation test results are presented in Table 12 and in FIG. 9.

TABLE 12

| | Total Carbon | Total | |
|---|---|---|---|
| | Present in the | Carbon | Biodegradation |
| | Polymers (%) (Avg | Present | (%) |
| Film Sample | of 3 Replicates) | (St. Dev.) | by Day 148 |
| Cellulose powder | N/a | N/a | 87.1 ± 3.1 |
| Blend 4-A | 60.13 | 0.56 | 27.5 ± 1.7 |
| Blend 7-A | 62.11 | 1.02 | 24.5 ± 0.3 |
| Blend 9-A | 73.87 | 0.36 | 10.5 ± 3.2 |
| Blend 10-A | 64.14 | 0.79 | 38.9 ± 2.6 |

The results demonstrate that Polymer Blend 10-A is on track to degrade by at least 90% within two years, which is required under some standards to be categorized as home compostable. Though not biodegrading as quickly, the remaining blends have also biodegraded by at least 10% within the testing period.

### Example 8—Summary of Results

Table 13 summarizes the performance of the best performing polymers described herein.

TABLE 13

| | Bio- | | | | Weight | | | | |
|---|---|---|---|---|---|---|---|---|---|
| | based | | | | loss | | | | |
| | content | | | | >3 | | | | |
| | >65 wt. | Disintegration | Tensile | | wt % | | | Heat | |
| Sample | % | <180 days | strength | Puncture | (days) | OTR* | WVTR** | sealable | Overall |
| PVOH | No | No | Yes | Yes | — | Yes | No | Yes | 5/8 |
| (control) | | | | | | | | | |
| C | No | No | Yes | Yes | 0.5 | No | No | Yes | 4/8 |
| D | No | No | Yes | Yes | 0.5 | No | No | Yes | 4/8 |
| 4-A | Yes | No | Yes | Yes | 4 | No | Yes | *** | 5/8 |
| 7-A | Yes | No | Yes | Yes | 9 | No | No | Yes | 5/8 |
| 9-A | Yes | No | Yes | No | 2 | No | Yes | Yes | 5/8 |
| 10-A | Yes | Yes | Yes | Yes | 1 | No | Yes | Yes | 7/8 |

*<10 (cc/m²/day)
**<10 (cc/m²/day)
***Sealable by ultrasonic sealer

Each of polymer samples C, D, 4-A, 7-A, 9-A, and 10-A are suitable for use in packaging films, either in a monolayer or in combination with one or more additional film layers. Of those, polymer Samples 4-A, 9-A, and 10-A are the most suitable for use as a packaging film for aqueous food products due to good water vapor barrier properties. Packaging films prepared from those polymer samples could be used in combination with one or more additional film layers that have good oxygen barrier properties to further improve the overall properties of the food packaging film.

Of the above samples, Sample 10-A was best performing with good disintegration, tensile strength, puncture resistance, water vapor transmission rate, and heat sealability.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of Applicant's contribution. The actual scope of the protection sought is intended to be defined in the following claims when viewed in their proper perspective based on the prior art.

1. A polymeric film comprising:
a film body comprising a polysuccinimide polymer formed by polycondensation of aspartic acid, the polysuccinimide polymer including a plurality of units including a cyclic imide moiety have a structure according to the following formula (I):

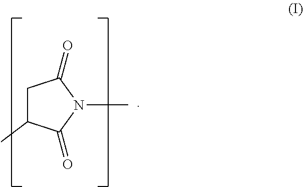

2. The polymeric film according to claim 1, wherein the polysuccinimide polymer has a molecular weight of from about 10,000 to about 65,000 Dalton.

3. The polymeric film according to claim 1, wherein the polysuccinimide polymer is in a blend with a polyester that has been transesterified with a dimer fatty acid.

4. The polymeric film according to claim 3, wherein the polysuccinimide polymer is included in an amount of about 1 wt % to about 15 wt. % and the transesterified polyester is included in an amount of about 85 wt. % to about 99 wt % based on the combined weight of the polysuccinimide polymer and transesterified polyester.

5. (canceled)

6. The polymeric film according to claim 3, wherein the transesterified polyester is one or more of polybutylene succinate (PBS), polybutylene succinate-co-adipate (PBSA), polybutylene adipate-co-terephthalate (PBAT), poly(3-hydroxybutyrate-co-3-hydroxyhexanoate (PBHB), and polylactic acid (PLA).

7. A process of forming a polysuccinimide polymeric film, the process comprising:
providing a polysuccinimide polymer including a plurality of units including a cyclic imide moiety, and
forming the polysuccinimide polymer into a film body.

8. The process according to claim 7, further comprising transesterifying a polyester with a dimer fatty acid, and combining the transesterified polyester with the polysuccinimide polymer.

9. The process according to claim 7, wherein the polysuccinimide polymer is included in an amount of about 1 wt % to about 15 wt. % and the transesterified polyester is included in an amount of about 85 wt. % to about 99 wt % based on the combined weight of the polysuccinimide polymer and transesterified polyester.

10. The process according to claim 7, wherein the transesterified polyester is one or more of polybutylene succinate (PBS), polybutylene succinate-co-adipate (PBSA), polybutylene adipate-co-terephthalate (PBAT), poly(3-hydroxybutyrate-co-3-hydroxyhexanoate (PBHB), and polylactic acid (PLA)

11. A polymeric film comprising:
a film body comprising a polysuccinimide polymer including one or more units including an amide moiety and one or more units including a cyclic imide moiety, and
wherein the one or more units including a cyclic imide moiety have a structure according to the following formula (I): 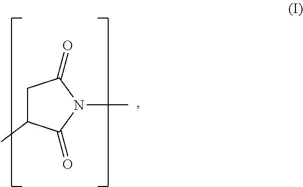
and
wherein the one or more units including an amide moiety comprise units according to the following formulas (II) and (III): 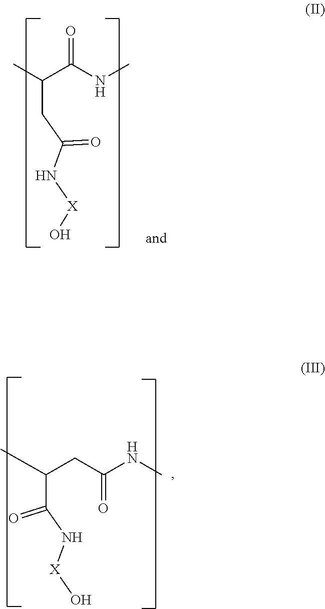
wherein Xs independently represent a divalent group including 1 to 4 carbon atoms.

12. The polymeric film according to claim 11, wherein the film body has a hydrophobic polymeric domain on at least one surface of the film body, the hydrophobic polymeric domain comprising a polymeric structure derived from the polymer and having higher hydrophobicity than the film body.

13. The polymeric film according to claim 11, wherein about 15% to about 85% of the total units of the polymer comprised in the film body have a structure according to formula (I) or about 15% to about 85% of the total units of the polymer in the film body are collectively composed of units according to the following formulas (II) and (III): 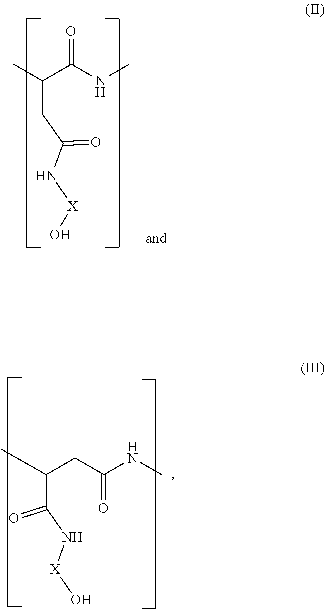
wherein Xs independently represent a divalent group including 1 to 4 carbon atoms.

14. (canceled)

15. The polymeric film according to claim 11, wherein the one or more units including an amide moiety comprise units according to the following formulas (IV) and (V):

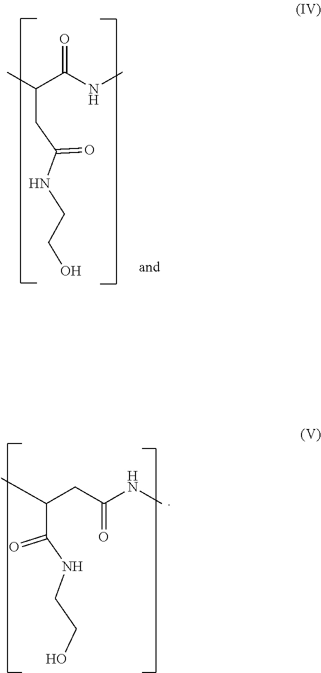

16. The polymeric film according to claim 12, wherein the polymeric structure of the hydrophobic polymeric domain comprises:
(1) units according to the following formulas (VI) and (VII): 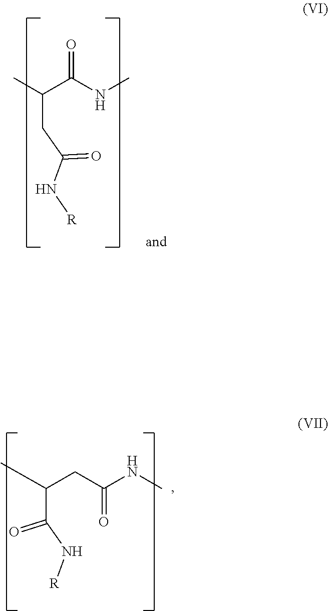
wherein Rs independently represent a monovalent group including 10 to 30 carbon atoms, and
(2) units according to the following formulas (II) and (III): 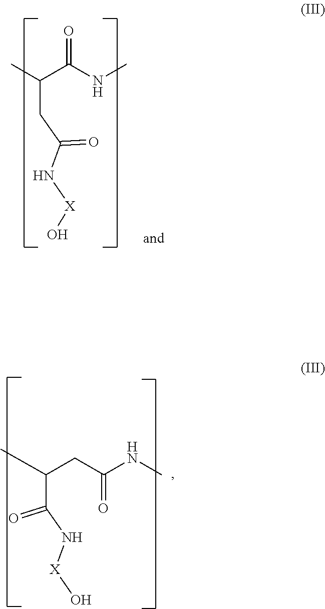
wherein Xs independently represent a divalent group including 1 to 4 carbon atoms.

17. The polymeric film according to claim 12, wherein the polymeric structure of the first hydrophobic polymeric domain and the polymeric structure of the second hydrophobic polymeric domain comprise:
units according to the following formulas (VI) and (VII): 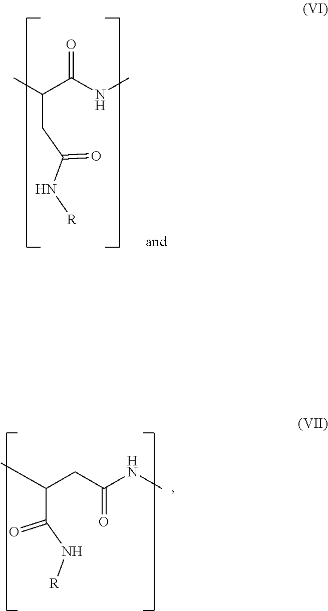
wherein Rs independently represent a monovalent group including 10 to 30 carbon atoms, and
units according to the following formulas (II) and (III): 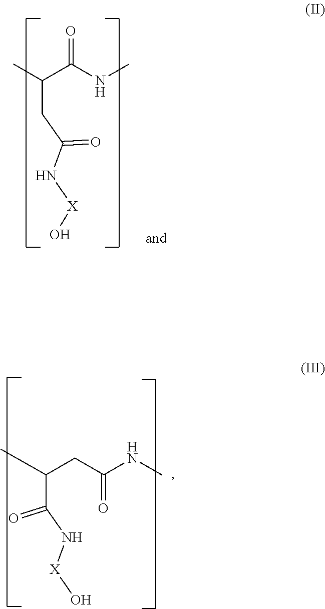
wherein X independently represent a divalent group including 1 to 4 carbon atoms.

18. (canceled)

19. (canceled)

20. A food sachet comprising:
a sachet body including the polymeric film according to claim 1, and
a food product enclosed in the sachet body.

21. The food sachet according to claim 20, wherein the food product has one of more of the following features:
a brix degree ranging from about 15° Bx to about 50° Bx;
a water activity ranging from about 0.90 to about 0.99;
a moisture content ranging from about 50 wt. % to about 95 wt. %; and
a pH ranging from 3.8 to 4.0.

22. (canceled)

23. A process of forming a polysuccinimide polymeric film, the process comprising:
providing a polysuccinimide polymer including one or more units including an amide moiety and one or more units including a cyclic imide moiety, and
forming the polysuccinimide polymer into a film body.

24. The process according to claim 23, further comprising treating a surface of the film body with an alcohol amine to form a hydrophobic polymeric domain on the surface of the film, the hydrophobic polymeric domain comprising a polymeric structure derived from the polysuccinimide polymer and having higher hydrophobicity than the film body.

25. The process according to claim 23, further comprising blending the polysuccinimide polymer with an additional polymer different from the polysuccinimide polymer and forming the blend into the film body, wherein the additional polymer comprises one or more of a polyester, polyvinyl alcohol, polyethylene, polypropylene, and polystyrene.

26. (canceled)

27. (canceled)
